(19) United States
(12) Patent Application Publication
(10) Pub. No.: US 2026/0332327 A1
(43) Pub. Date: Oct. 22, 2026

(54) CONFIGURING CORESETS FOR BANDWIDTH PART SWITCHING

(71) Applicant: Lenovo (United States) Inc., Morrisville, NC (US)

(72) Inventors: Hossein Bagheri, Dearborn Heights, MI (US); Karthikeyan Ganesan, Nauheim (DE); Khaled Nafez Rauf Ardah, Ilmenau (DE)

(73) Assignee: Lenovo (United States) Inc., Morrisville, NC (US)

(21) Appl. No.: 19/578,752

(22) Filed: Mar. 25, 2026

(51) Int. Cl. H04L 5/00

(52) U.S. Cl. CPC H04L 5/0044; H04L 5/0005

(57) ABSTRACT

Various aspects of the present disclosure relate to configuring control resource sets (CORESETs) for bandwidth part (BWP) switching. A user equipment (UE) may receive signaling that indicates a first CORESET and a second CORESET. The first CORESET is associated with a first BWP and a second BWP. The second CORESET is associated with the second BWP. The UE may receive a first downlink control channel in the first CORESET. The first downlink control channel indicates to switch from the first BWP to the second BWP. The UE refrains from monitoring the second CORESET prior to transmission of feedback in response to the first downlink control channel. The UE transmits the feedback in response to the first downlink control channel and monitors the first CORESET and the second CORESET for the second downlink control channel based on the feedback and switching from the first BWP to the second BWP.

### TECHNICAL FIELD

The present disclosure relates to wireless communications, and more specifically to managing time-frequency resources for the wireless communications.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies, including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive signaling that indicates a first control resource set (CORESET) and a second CORESET, where the first CORESET is associated with a first bandwidth part (BWP) and a second BWP, and where the second CORESET is associated with the second BWP, receive, in the first CORESET, a first downlink control channel (e.g., a physical downlink control channel (PDCCH)) that indicates to switch from the first BWP to the second BWP, switch, based on the first downlink control channel, from the first BWP to the second BWP, refrain, prior to transmission of feedback in response to the first downlink control channel, from monitoring the second CORESET for a second downlink control channel, transmit the feedback in response to the first downlink control channel, and monitor, based on the feedback and switching from the first BWP to the second BWP, the first CORESET and the second CORESET for the second downlink control channel.

A processor (e.g., a standalone processor chipset, or a component of a UE) for wireless communication is described. The processor may be configured to, capable of, or operable to perform one or more operations as described herein. For example, the processor may be configured to, capable of, or operable to receive signaling that indicates a first CORESET and a second CORESET, where the first CORESET is associated with a first BWP and a second BWP, and where the second CORESET is associated with the second BWP, receive, in the first CORESET, a first downlink control channel that indicates to switch from the first BWP to the second BWP, switch, based on the first downlink control channel, from the first BWP to the second BWP, refrain, prior to transmission of feedback in response to the first downlink control channel, from monitoring the second CORESET for a second downlink control channel, transmit the feedback in response to the first downlink control channel, and monitor, based on the feedback and switching from the first BWP to the second BWP, the first CORESET and the second CORESET for the second downlink control channel.

A method performed or performable by a UE for wireless communication is described. The method may include receiving signaling that indicates a first CORESET and a second CORESET, where the first CORESET is associated with a first BWP and a second BWP, and where the second CORESET is associated with the second BWP, receiving, in the first CORESET, a first downlink control channel that indicates to switch from the first BWP to the second BWP, switching, based on the first downlink control channel, from the first BWP to the second BWP, refraining, prior to transmission of feedback in response to the first downlink control channel, from monitoring the second CORESET for a second downlink control channel, transmitting the feedback in response to the first downlink control channel, and monitoring, based on the feedback and switching from the first BWP to the second BWP, the first CORESET and the second CORESET for the second downlink control channel.

In some implementations of the UE, the processor, and the method described herein, the UE, the processor, and the method may further be configured to, capable of, or operable to monitor, prior to the transmission of the feedback and after switching from the first BWP to the second BWP, at least a subset of the first CORESET for the second downlink control channel. In some implementations, the UE, the processor, and the method may further be configured to, capable of, or operable to receive the second downlink control channel based on monitoring the first CORESET and the second CORESET, where the second downlink control channel schedules a downlink shared channel (e.g., a physical downlink shared channel (PDSCH)), receive the downlink shared channel, transmit additional feedback in response to decoding the downlink shared channel, and monitor the first CORESET and the second CORESET for one or more third downlink control channels based on the additional feedback. In some implementations, the first BWP and the second BWP include one or more overlapping resource blocks (RBs), and the UE, the processor, and the method may further be configured to, capable of, or operable to determine at least one RB index associated with the downlink shared channel based on a set of RB indices associated with the first BWP, where the downlink shared channel is received in the one or more overlapping RBs based on the at least one RB index.

In some implementations, an RB indexing for the largest configured BWP in a cell is also applicable to at least a set of smaller configured BWPs for the cell. In some implementations, RBs present in both the first BWP and the second BWP have the same RB index across the first and second BWPs.

In some implementations, the UE, the processor, and the method may further be configured to, capable of, or operable to start, after receiving the first downlink control channel, a timer associated with monitoring the first CORESET for the second downlink control channel, and refrain from monitoring the first CORESET for the second downlink control channel based on expiry of the timer. In some implementations, the first downlink control channel schedules a downlink shared channel, and the UE, the processor, and the method may further be configured to, capable of, or operable to receive the downlink shared channel, where the feedback includes an acknowledgment in response to decoding the downlink shared channel. In some implementations, the first downlink control channel schedules a downlink shared channel, and the UE, the processor, and the method may further be configured to, capable of, or operable to receive the downlink shared channel, and the downlink shared channel is a downlink broadcast channel (e.g., a downlink broadcast channel carrying system information block (SIB) 1 (SIB1) information), for which the UE does not provide feedback. In some implementations, the initial timer value can be set to a value according to SIB1 periodicity and repetition. In some implementations, the first downlink control channel is independent of a downlink shared channel, and the feedback includes an acknowledgment in response to decoding the first downlink control channel.

In some implementations, the signaling indicates a first numerical quantity of time resources associated with the first CORESET in the first BWP and a second numerical quantity of time resources associated with the first CORESET in the second BWP, and the UE, the processor, and the method may further be configured to, capable of, or operable to monitor, prior to the transmission of the feedback and after switching from the first BWP to the second BWP, the first CORESET for the second downlink control channel based on the first numerical quantity of time resources, and monitor, after transmitting the feedback, the first CORESET for the second downlink control channel based on the second numerical quantity of time resources. In some implementations, the signaling indicates a first numerical quantity of time resources associated with the first CORESET in the first BWP and a second numerical quantity of time resources associated with the first CORESET in the second BWP, and the UE, the processor, and the method may further be configured to, capable of, or operable to monitor, prior to the transmission of the feedback and after switching from the first BWP to the second BWP, the first CORESET for the second downlink control channel based on the second numerical quantity of time resources.

In some implementations, the UE, the processor, and the method may further be configured to, capable of, or operable to refrain from performing radio frequency retuning based on the first BWP and the second BWP including one or more overlapping RBs and having a same center frequency. In some implementations, the UE, the processor, and the method may further be configured to, capable of, or operable to monitor, prior to the transmission of the feedback and after switching from the first BWP to the second BWP, the first CORESET for the second downlink control channel based on a search space set associated with the first CORESET in the first BWP. In some implementations, the first CORESET includes a set of one or more CORESETs configured for the first BWP. In some implementations, the UE, the processor, and the method may further be configured to, capable of, or operable to select the first CORESET from a set of CORESETs configured for the first BWP based on one or more of a size of the first CORESET having a greatest value of the set of CORESETs, the first CORESET being configured for BWP switching, or the first CORESET having a greatest numerical quantity of overlapping RBs between the first BWP and the second BWP. In some implementations, the UE, the processor, and the method may further be configured to, capable of, or operable to monitor, prior to the transmission of the feedback and after switching from the first BWP to the second BWP, the first CORESET for the second downlink control channel based on the second BWP being greater than the first BWP.

In some implementations, a first CORESET is configured for a first BWP, and the UE, the processor, and the method may further be configured to, capable of, or operable to determine a second CORESET for the second BWP based on the first CORESET of the first BWP, and/or RBs or BW of the first and the second BWP. In some implementations, after receiving the command to transition from the first BWP to the second BWP, the UE, the processor, and the method may further be configured to, capable of, or operable to start monitoring the second CORESET at least until transmitting an acknowledgement in response to a DCI or until a timer expires. In some implementations, the second CORESET is a subset of the first CORESET.

An NE (e.g., a base station) for wireless communication is described. The NE may be configured to, capable of, or operable to perform one or more operations as described herein. For example, the NE may be configured to, capable of, or operable to transmit signaling that indicates a first CORESET and a second CORESET, where the first CORESET is associated with a first BWP and a second BWP, and where the second CORESET is associated with the second BWP, transmit, in the first CORESET, a first downlink control channel that indicates to switch from the first BWP to the second BWP, refrain from transmitting, prior to reception of feedback in response to the first downlink control channel, a second downlink control channel in the second CORESET, receive the feedback in response to the first downlink control channel, and transmit, based on the feedback and in at least one of the first CORESET or the second CORESET, the second downlink control channel.

A processor (e.g., a standalone processor chipset, or a component of an NE) for wireless communication is described. The processor may be configured to, capable of, or operable to perform one or more operations as described herein. For example, the processor may be configured to, capable of, or operable to transmit signaling that indicates a first CORESET and a second CORESET, where the first CORESET is associated with a first BWP and a second BWP, and where the second CORESET is associated with the second BWP, transmit, in the first CORESET, a first downlink control channel that indicates to switch from the first BWP to the second BWP, refrain from transmitting, prior to reception of feedback in response to the first downlink control channel, a second downlink control channel in the second CORESET, receive the feedback in response to the first downlink control channel, and transmit, based on the feedback and in at least one of the first CORESET or the second CORESET, the second downlink control channel.

A method performed or performable by an NE (e.g., a base station) for wireless communication is described. The method may include transmitting signaling that indicates a first CORESET and a second CORESET, where the first CORESET is associated with a first BWP and a second BWP, and where the second CORESET is associated with the second BWP, transmitting, in the first CORESET, a first downlink control channel that indicates to switch from the first BWP to the second BWP, refraining from transmitting, prior to reception of feedback in response to the first downlink control channel, a second downlink control channel in the second CORESET, receiving the feedback in response to the first downlink control channel, and transmitting, based on the feedback and in at least one of the first CORESET or the second CORESET, the second downlink control channel.

In some implementations of the NE, the processor, and the method described herein, the NE, the processor, and the method may further be configured to, capable of, or operable to transmit, prior to the reception of the feedback and after transmitting the first downlink control channel, the second downlink control channel in at least a subset of the first CORESET. In some implementations, the NE, the processor, and the method may further be configured to, capable of, or operable to transmit the second downlink control channel, where the second downlink control channel schedules a downlink shared channel, transmit the downlink shared channel, receive additional feedback in response to decoding the downlink shared channel, and transmit one or more third downlink control channels in the first CORESET and the second CORESET based on the additional feedback. In some implementations, the first BWP and the second BWP include one or more overlapping RBs, and the NE, the processor, and the method may further be configured to, capable of, or operable to determine at least one RB index associated with the downlink shared channel based on a set of RB indices associated with the first BWP, where the downlink shared channel is transmitted in the one or more overlapping RBs based on the at least one RB index.

In some implementations, the first downlink control channel schedules a downlink shared channel, and the NE, the processor, and the method may further be configured to, capable of, or operable to transmit the downlink shared channel to a UE, where the feedback includes an acknowledgement that indicates successful reception and decoding of the downlink shared channel at the UE. In some implementations, the first downlink control channel is independent of a downlink shared channel, and the feedback includes an acknowledgment in response to decoding the first downlink control channel.

In some implementations, the signaling indicates a first numerical quantity of time resources associated with the first CORESET in the first BWP and a second numerical quantity of time resources associated with the first CORESET in the second BWP, and the NE, the processor, and the method may further be configured to, capable of, or operable to transmit, prior to the reception of the feedback and after transmitting the first downlink control channel, the second downlink control channel during the first CORESET based on the first numerical quantity of time resources, and transmit, after receiving the feedback, the second downlink control channel during the first CORESET based on the second numerical quantity of time resources. In some implementations, the signaling indicates a first numerical quantity of time resources associated with the first CORESET in the first BWP and a second numerical quantity of time resources associated with the first CORESET in the second BWP, and the NE, the processor, and the method may further be configured to, capable of, or operable to transmit, prior to the reception of the feedback and after transmitting the first downlink control channel, the second downlink control channel during the first CORESET based on the second numerical quantity of time resources.

In some implementations, the NE, the processor, and the method may further be configured to, capable of, or operable to transmit, prior to the reception of the feedback and after transmitting the first downlink control channel, the second downlink control channel during the first CORESET based on a search space set associated with the first CORESET in the first BWP. In some implementations, the first CORESET includes a set of one or more CORESETs configured for the first BWP. In some implementations, the NE, the processor, and the method may further be configured to, capable of, or operable to select the first CORESET from a set of CORESETs configured for the first BWP based on one or more of a size of the first CORESET having a greatest value of the set of CORESETs, the first CORESET being configured for BWP switching, or the first CORESET having a greatest numerical quantity of overlapping RBs between the first BWP and the second BWP. In some implementations, the NE, the processor, and the method may further be configured to, capable of, or operable to transmit, prior to the reception of the feedback and after transmitting the first downlink control channel, the second downlink control channel during the first CORESET based on the second BWP being greater than the first BWP.

### BRIEF DESCRIPTION OF THE DRAWINGS

FIG. 1 illustrates an example of a wireless communications system in accordance with aspects of the present disclosure.

FIG. 2 illustrates an example of a resource diagram, in accordance with aspects of the present disclosure.

FIGS. 3 through 10 illustrate examples of transmission diagrams, in accordance with aspects of the present disclosure.

FIGS. 11 and 12 illustrate examples of signaling diagrams, in accordance with aspects of the present disclosure.

FIG. 13 illustrates an example of a UE in accordance with aspects of the present disclosure.

FIG. 14 illustrates an example of a processor in accordance with aspects of the present disclosure.

FIG. 15 illustrates an example of an NE in accordance with aspects of the present disclosure.

FIG. 16 illustrates a flowchart of a method performed by a UE in accordance with aspects of the present disclosure.

FIG. 17 illustrates a flowchart of a method performed by an NE in accordance with aspects of the present disclosure.

### DETAILED DESCRIPTION

In a wireless communications system, a UE and an NE (e.g., a base station, a gNB) may support transmission and reception of signaling, referred to as wireless communication. For example, the NE may transmit signaling that configures the UE with a set of BWPs, where each BWP spans a subset of frequency resources within a frequency band. The NE may also configure the UE with one or more CORESETs for each BWP, where a CORESET defines time-frequency resources in which the UE monitors for downlink control channels, such as PDCCHs. The NE may transmit additional signaling to activate (e.g., for wireless communication) a configured BWP, and the UE may monitor the CORESETs configured for the activated BWP for PDCCHs. The NE may transmit the PDCCHs that include control information, such as downlink control information (DCI), which schedules a PDSCH and/or indicates a BWP switch from the active BWP to a different configured BWP. In some examples, the UE may switch to the different configured BWP to receive additional downlink communication, such as a PDSCH scheduled by a PDCCH. However, the UE may be unaware of the CORESETs to monitor during the BWP switching process, such as before the NE has confirmation that the UE successfully received the BWP switch indication. If the UE begins monitoring one or more CORESETs for a new BWP (e.g., the BWP the UE switched to) immediately after switching to the new BWP, but the NE is unaware that the UE has switched, then the NE may not transmit PDCCHs in the CORESETs for the new BWP. Additionally, or alternatively, if the UE fails to receive and/or decode a PDCCH indicating a BWP switch, then the NE may be unaware that the UE failed to receive the BWP switch indication, resulting in a misalignment between the NE and the UE regarding the active BWP and the CORESETs being monitored. The UE being unaware of the CORESETs to monitor during the BWP switch may cause communication failures, missed signaling, or unnecessary power consumption due to the UE monitoring CORESETs that the NE is not using for transmission.

As described herein, to address the misalignment between the NE and the UE regarding BWP switching and to improve reliability of downlink control channel reception, the NE and the UE may implement a common CORESET configuration that spans multiple BWPs. The NE may transmit signaling to the UE that indicates a first CORESET and a second CORESET. The NE may configure the first CORESET for both a first BWP and a second BWP, while the NE may configure the second CORESET for the second BWP. The NE may transmit a first PDCCH in the first CORESET that indicates to switch from the first BWP to the second BWP. Upon receiving the first PDCCH, the UE may switch from the first BWP to the second BWP. Prior to transmission of feedback in response to the first PDCCH, the UE may refrain from monitoring the second CORESET for a second PDCCH. During this period, the UE may continue to monitor at least a subset of the first CORESET, which serves as a common CORESET between the first BWP and the second BWP. After the UE transmits the feedback in response to the first PDCCH, the UE may monitor both the first CORESET and the second CORESET for the second PDCCH. Similarly, the NE may refrain from transmitting the second PDCCH in the second CORESET prior to reception of the feedback, and may transmit the second PDCCH in at least one of the first CORESET or the second CORESET based on the feedback.

By performing the described techniques, a device (e.g., a UE and/or an NE) in a wireless communications system may provide for improved reliability and performance due to reduced misalignment during BWP switching. For example, by configuring a common CORESET for both the first BWP and the second BWP, the UE may maintain PDCCH reception continuity during the BWP transition period. The UE may continue to monitor the common CORESET after switching to the second BWP and before transmitting feedback, enabling the NE to transmit PDCCHs that the UE receives, regardless of whether the NE has confirmed the BWP switch. The described techniques may reduce unnecessary power consumption at the UE by enabling the UE to refrain from monitoring the second CORESET until the feedback is transmitted, thereby reducing the number of CORESETs that the UE monitors during the transition period. Additionally, or alternatively, the described techniques may reduce communication failures caused by misalignment between the NE and the UE regarding the active BWP and the CORESETs being monitored.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings, is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

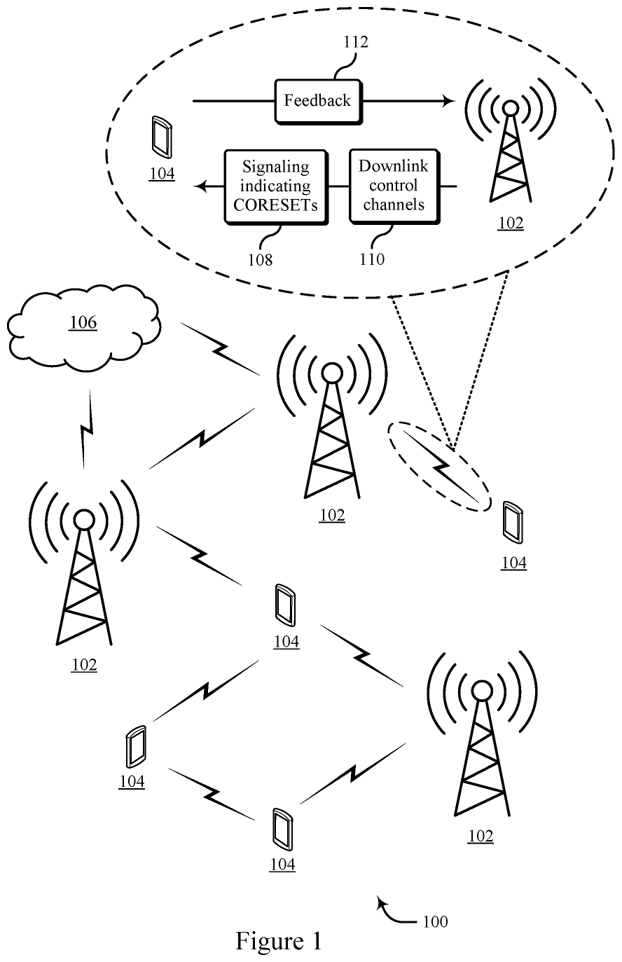

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology, including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be, or include, or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be movable, for example, a satellite associated with a non-terrestrial network (NTN). In some implementations, different geographic coverage areas associated with the same or different radio access technologies may overlap, but the different geographic coverage areas may be associated with different NEs 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or a machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NEs 102 or the CN 106 through one or more backhaul links (e.g., S1, N2, N6, or other network interface). In some implementations, the NEs 102 may communicate with each other directly. In some other implementations, the NEs 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplex (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHZ-24.25 GHz), FR4 (52.6 GHz-114.25 GHz), FR4a or FR4-1 (52.6 GHZ-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least two numerologies). For example, FR2 may be associated with a third numerology (e.g., μ=2), which includes 60 kHz subcarrier spacing; and a fourth numerology (e.g., μ=3), which includes 120 kHz subcarrier spacing.

In the wireless communications system 100, the NEs 102 and the UEs 104 may communicate using downlink control channels and downlink shared channels, such as PDCCHs and PDSCHs. A downlink control channel may carry control information from an NE 102 to a UE 104. The control information may include scheduling information (e.g., modulation and coding scheme (MCS), transport block (TB) size, redundancy version (RV)), resource assignments (e.g., time-frequency resource allocations for uplink or downlink transmissions, antenna port assignments), power control commands (e.g., transmit power control commands for uplink channels), and/or other control signaling (e.g., HARQ process identifiers, new data indicators (NDIs), BWP indicators). For example, a PDCCH may carry DCI that schedules downlink data transmissions on a PDSCH, schedules uplink data transmissions on a physical uplink shared channel (PUSCH), and/or indicates other control commands, such as BWP switching.

In some cases, a downlink control channel may include one or more control-channel elements (CCEs), as indicated in Table 1.

TABLE 1
Supported downlink control channel aggregation levels.

| Aggregation level | Number of CCEs |
|---|---|
| 1 | 1 |
| 2 | 2 |
| 4 | 4 |
| 8 | 8 |
| 16 | 16 |

A CCE may be an example of a basic resource unit used to construct a downlink control channel, where each CCE includes a set of resource element groups (REGs) that carry modulation symbols of the downlink control channel. The number of CCEs used for a downlink control channel transmission may depend on an aggregation level, which the NE 102 may select based on channel conditions and the payload size of the DCI. For example, a higher aggregation level (e.g., more CCEs) may provide greater reliability for downlink control channel reception.

The NE 102 may transmit a downlink control channel within a CORESET. A CORESET may define a set of time-frequency resources in which the UE 104 monitors for downlink control channels. The CORESET may indicate one or more frequency domain resources (e.g., RBs) and one or more time domain resources (e.g., symbols) in which downlink control channel candidates may be located. A control-resource set may include a numerical quantity of RBs in the frequency domain,

$${N}_{NB}^{CORESET} ,$$

and a numerical quantity of symbols in the time domain,

$${N}_{symb}^{CORESET} ∈ \{ 1 , 2 , 3 \} .$$

A CCE may include a numerical quantity of REGs (e.g., six REGs), where a REG is an RB during an OFDM symbol. REGs within a CORESET are numbered in increasing order in a time-first manner, starting with zero for the first OFDM symbol and the lowest-numbered RB in the control resource set.

A UE 104 can be configured with multiple CORESETs. Each CORESET is associated with one CCE-to-REG mapping. A CCE-to-REG mapping defines how the REGs of a CORESET are assigned to CCEs, determining the physical resource locations used for transmitting a downlink control channel. The CCE-to-REG mapping for a CORESET can be interleaved or non-interleaved and is described by REG bundles. For example, REG bundle i is defined as REGs {iL, iL+1, . . . , iL+L−1}, where L is the REG bundle size,

$$i = 0 , 1 , … , {N}_{REG}^{CORESET} / L - 1 , and {N}_{REG}^{CORESET} = {N}_{RB}^{CORESET} {N}_{symb}^{CORESET}$$

is the number of REGs in the CORESET. A CCE j includes REG bundles {f(6j/L), f(6j/L+1), . . . , f(6j/L+6/L−1)}, where f(·) is an interleaver. The interleaver is a function that permutes the REG bundle indices to distribute the CCE resources across the CORESET, which may provide frequency diversity and improve robustness against localized interference or fading. For non-interleaved mapping, the REG bundles of a CCE are contiguous in the frequency domain. For interleaved mapping, the REG bundles of a CCE are distributed across the CORESET according to the interleaver function. For example, for non-interleaved CCE-to-REG mapping, L=6 and f(x)=x. For interleaved CCE-to-REG mapping,

$$L ∈ \{ 2 , 6 \} for {N}_{symb}^{CORESET} = 1 and L ∈ \{ {N}_{symb}^{CORESET} , 6 \} for {N}_{symb}^{CORESET} ∈ \{ 2 , 3 \} .$$

The interleaver is defined by Equation 1:

$$f ( x ) = ( rC + c + {n}_{shift} ) mod ( {N}_{REG}^{CORESET} / L ) , \qquad ( 1 )$$

where

$$x = cR + r , r = 0 , 1 , … , R - 1 , c = 0 , 1 , … , C - 1 , C = {N}_{REG}^{CORESET} / ( LR ) ,$$

$$and R ∈ \{ 2 , 3 , 6 \} .$$

The UE is not expected to handle configurations resulting in the quantity C not being an integer.

For a CORESET configured by the ControlResourceSet information element (IE),

$${N}_{RB}^{CORESET}$$

is given by the higher-layer parameter frequencyDomainResources. Additionally, or alternatively,

$${N}_{symb}^{CORESET}$$

is given by the higher-layer parameter duration, where

$${N}_{symb}^{CORESET} = 3$$

is supported if the higher-layer parameter dmrs-TypeA-Position equals a value of pos3. Additionally, or alternatively, interleaved or non-interleaved mapping is given by the higher-layer parameter cce-REG-MappingType. Additionally, or alternatively, L equals a default integer value (e.g., six) for non-interleaved mapping and is given by the higher-layer parameter reg-BundleSize for interleaved mapping. Additionally, or alternatively, R is given by the higher-layer parameter interleaverSize. Additionally, or alternatively, n_{shift}∈{0, 1, . . . , 274} is given by the higher-layer parameter shiftIndex if provided, otherwise

$${n}_{shift} = {N}_{ID}^{cell}$$

For both interleaved and non-interleaved mapping, if the higher-layer parameter precoderGranularity equals same AsREG-bundle, then the UE 104 may assume the same precoding is being used within a REG bundle. If the higher-layer parameter precoderGranularity equals allContiguousRBs, then the UE 104 may assume the same precoding is being used across the REGs within the set of contiguous RBs in the CORESET. The UE 104 may assume that no resource elements (REs) in the CORESET overlap with a synchronization signal block (SSB). In some cases, such as for 6G, the CORESET duration may be extended to more than three symbols (e.g., six or twelve symbols) to compensate for small frequency allocation (e.g., for IoT).

In some cases, if a UE transitions from a first BWP to a second BWP, if a CORESET is monitored in the first BWP, and if a subset of the CORESET is monitored in the second BWP (e.g., the second BWP is smaller than the first BWP), then a restriction on a CCE-to-REG mapping is applicable. The CCE-to-REG mapping may be a non-interleaving mapping and/or the non-interleaved mapping may apply to the subset of the CORESET. For example, a block interleaving is applicable to the CORESET, where each block size is at least the size of the subset of the CORESET.

A UE 104 may monitor for downlink control channels within a search space set, where the search space set defines a set of downlink control channel candidates that the UE 104 is configured to monitor within a CORESET. For a search space set, s, associated with a CORESET, p, the UE 104 may determine CCE indexes for an aggregation level, L. The CCE indexes correspond to a downlink control channel candidate,

$${m}_{s , {n}_{CI}}^{( L )} ,$$

of the search space set in a slot,

$${n}_{s , f}^{μ} .$$

The UE 104 may determine the CCE indexes for an active downlink BWP of a serving cell corresponding to a carrier indicator field value n_{CI}, or corresponding to a value n_{CI} of nCI-Value associated with a set of serving cells MC-DCI-SetofCells. The CCE indexes may be calculated using Equation 2:

$$L \cdot \{ ( {Y}_{p , {n}_{s , f}^{μ}} + ⌊ \frac{{m}_{s , {n}_{CI}}^{( L )} \cdot {N}_{CCE , p}}{L \cdot {M}_{s , max}^{( L )}} ⌋ + {n}_{CI} ) mod ⌊ {N}_{CCE , p} / L ⌋ \} + i \qquad ( 2 )$$

A search space set may be a common search space (CSS) or a UE-specific search space (USS). Multiple UEs 104 may monitor a CSS and may include system information, paging, and other common signaling. A USS is a search space set configured for a UE 104 and is used for UE-specific scheduling and control signaling. For a CSS,

$${Y}_{p , {n}_{s , f}^{μ}} = 0.$$

For a CSS, the starting candidate index

$${Y}_{p , {n}_{s , f}^{μ}} = 0 , where {Y}_{p , {n}_{s , f}^{μ}}$$

represents a hashing value used to determine downlink control channel candidate locations for CORESET p in slot

$${n}_{s , f}^{μ} .$$

For a USS, the hashing value is computed as

$${Y}_{p , {n}_{s , f}^{μ}} = ( {A}_{p} \cdot {Y}_{p , {n}_{s , f}^{μ} - 1} ) mod D ,$$

with an initial value Y_{p,-1}=n_{RNTI}≠0, where n_{RNTI} is the radio network temporary identifier (RNTI) associated with the UE. The constant Aₚ is a CORESET-dependent multiplier defined as Aₚ=39827 for pmod3=0, Aₚ=39829 for pmod3=1, and Aₚ=39839 for pmod3=2. The modulus D=65537 is a prime number used to ensure uniform distribution of candidate locations. The index i=0, . . . , L−1 represents the downlink control channel candidate index within the search space, where Lis the aggregation level. N_{CCE,p} is the number of CCEs, numbered from 0 to N_{CCE,p}−1, in CORESET p and, if any, per RB set. For CORESET 0, the CCEs are obtained prior to puncturing, if any, of corresponding RBs. In some cases, n_{CI} is the carrier indicator field value, if provided by cif-InSchedulingCell in CrossCarrierSchedulingConfig for the serving cell on which PDCCH is monitored, except for scheduling of the serving cell from the same serving cell in which case n_{CI}=0. In some other cases, n_{CI} is the nCI-Value provided for the set of serving cells MC-DCI-SetofCells, if MC-DCI-SetofCells is provided. Otherwise, including for any CSS, n_{CI}=0. The parameter,

$${m}_{s , {n}_{CI}}^{( L )} = 0 , … , {M}_{s , {n}_{CI}}^{( L )} - 1 , where {M}_{s , {n}_{CI}}^{( L )} ,$$

is the number of downlink control channel candidates the UE 104 is configured to monitor for aggregation level, L, of a search space set, s, for a serving cell corresponding to n_{CI}. In some cases, for any CSS,

$${M}_{s , max}^{( L )} = {M}_{s , 0}^{( L )} .$$

In some other cases, for a USS,

$${M}_{s , max}^{( L )}$$

is the maximum of

$${M}_{s , {n}_{CI}}^{( L )}$$

over an configured n_{CI} values for a CCE aggregation level, L, of search space set, s. An RNTI value used for n_{RNTI} is a cell-RNTI (C-RNTI).

In the wireless communications system 100, the UE 104 may provide feedback to the NE 102 regarding reception of downlink shared channels scheduled by downlink control channels. The feedback may include hybrid automatic repeat request (HARQ) feedback, which indicates whether the UE 104 successfully received and decoded a downlink shared channel. HARQ is a technique that combines forward error correction (FEC) with automatic repeat request (ARQ) to improve transmission reliability. In HARQ, a receiver (e.g., at the UE 104 for a downlink control channel and/or a downlink shared channel) attempts to decode a received transmission and, if decoding fails, requests a retransmission from a transmitter (e.g., the NE 102 for a downlink control channel and/or a downlink shared channel). The receiver may combine the original transmission with the retransmission to improve decoding success. HARQ feedback may include a HARQ acknowledgment (HARQ-ACK) or acknowledgement (ACK) indicating successful reception and decoding of the downlink shared channel, or a HARQ negative acknowledgment (HARQ-NACK) or negative acknowledgment (NACK) indicating unsuccessful reception or decoding of (e.g., failure to receive and/or decode) the downlink shared channel. The NE 102 may use the HARQ feedback to determine whether to retransmit the downlink shared channel or to proceed with transmitting new data. The feedback provided by the UE 104 is not limited to HARQ feedback and may include other types of feedback.

In some examples, the UE 104 may provide event-based HARQ feedback in response to one or more events. For example, a semi-persistent scheduling PDSCH release, secondary cell (SCell) dormancy, and/or transmission configuration indicator (TCI) state update may be examples of events that trigger HARQ-ACK reporting, and may not involve PDSCH transmission. For semi-persistent scheduling, the NE 102 allocates periodic resources to the UE 104 for data transmission without dynamic scheduling for each transmission. A semi-persistent scheduling PDSCH release is a command from the NE 102 that terminates the SPS configuration, after which the UE 104 no longer expects periodic PDSCH transmissions on the previously allocated resources. An SCell is a secondary serving cell configured for the UE 104 in addition to a primary cell (PCell), and SCell dormancy is a state in which the SCell is deactivated or in a low-power mode to reduce power consumption at the UE 104. A TCI state is a configuration that indicates spatial parameters, such as beam directions and quasi-co-location (QCL) relationships, for downlink or uplink transmissions, and a TCI state update is a change in the TCI state configuration.

The HARQ-ACK bits for the events are included in a Type-2 HARQ-ACK codebook, which uses a total and/or a counter downlink assignment index (DAI) to determine bit positions. A Type-2 HARQ-ACK codebook is a dynamic codebook, where the size is determined by the number of scheduled transmissions indicated by the DAI values in the received DCIs. A DAI is a field included in DCI that tracks a cumulative count of scheduled transmissions, enabling the UE 104 to determine an expected size and structure of the HARQ-ACK codebook. The DAI may include a counter DAI, which indicates the number of scheduled transmissions within a single downlink control channel monitoring occasion, and a total DAI, which indicates the cumulative number of scheduled transmissions across all downlink control channel monitoring occasions up to and including the current occasion. The events are counted as valid HARQ-ACK-bearing instances, which are then mapped to DAI slots, ensuring a deterministic bit location in the codebook. The total DAI is updated per downlink control channel monitoring occasion and indicates the total number of HARQ-relevant DCIs across each component carrier in the current monitoring occasion. In some cases, multiple DCIs in the same occasion share the same total DAI value. The counter DAI is updated per downlink control channel monitoring occasion, and multiple DCIs in the same occasion are associated with increasing counter DAI values according to a rule (e.g., increasing each of the following in order: (1) PDSCH reception start time and/or PDCCH monitoring time for non-scheduling DCIs, (2) serving cell index, (3) PDCCH monitoring occasion), and indicates the cumulative number of HARQ-relevant DCIs up to the current monitoring occasion. If a DCI triggering one of the events is missed, then the corresponding HARQ-ACK bit position will be filled with a NACK.

In some examples, the UE 104 may fail to successfully receive and decode a downlink control channel transmission, which may be referred to as misdetection (e.g., PDCCH misdetection). Downlink control channel misdetection occurs if the UE 104 does not correctly receive or decode a downlink control channel transmission from the NE 102, resulting in the UE 104 being unaware of the scheduling information or control commands in the missed downlink control channel. The UE 104 and/or the NE 102 may implement feedback techniques for downlink control channel detection as part of a downlink shared channel HARQ feedback framework to limit the impact of missed downlink assignments on adaptive downlink HARQ operation and to improve downlink control reliability. For adaptive HARQ operation, the NE 102 dynamically adjusts transmission parameters, such as MCS, RV, and/or resource allocation, according to channel conditions and feedback from the UE 104. The feedback techniques may include using a NACK with multiple values to differentiate between downlink shared channel decoding failure and not detecting a downlink assignment, or providing an indication of the number of detected downlink control channels or failed downlink shared channel decoding for the reported HARQ-ACK codebook. Additionally, or alternatively, the feedback techniques may indicate DCI missed detection for NACK information bits in a HARQ-ACK codebook.

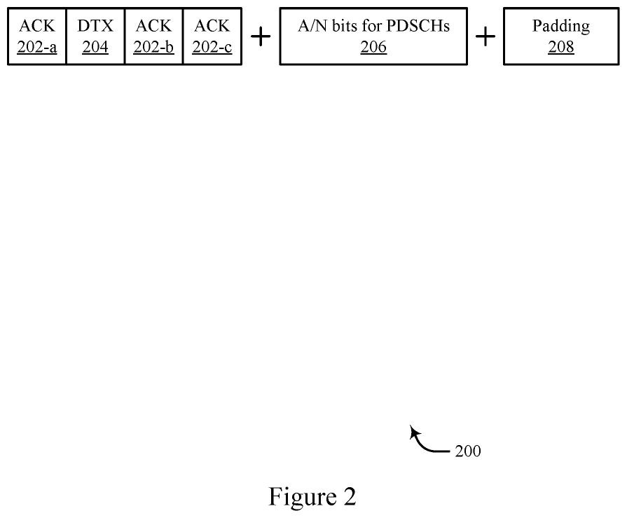

A HARQ-ACK codebook size mismatch may occur when one or more last DCIs are missing, resulting in the UE 104 constructing a codebook with fewer bits than expected by the NE 102. A HARQ-ACK codebook is a structured collection of feedback bits that the UE 104 transmits to the NE 102, where each bit corresponds to a scheduled downlink transmission and indicates whether the UE 104 successfully decoded the corresponding downlink shared channel. The codebook size is determined based on the total DAI value, which indicates the cumulative number of scheduled transmissions. If the UE 104 misses one or more DCIs, such as the last DCI or DCIs in a sequence, then the UE 104 may not be aware of a total number of scheduled transmissions. As a result, the UE 104 constructs a codebook based on the highest total DAI value received, which may be smaller than the codebook size expected by the NE 102. The mismatch can cause the NE 102 to misinterpret the feedback bits. For example, the NE 102 may associate a NACK intended for one transmission with a different transmission or interpret a discontinuous transmission (DTX) as a NACK. A DTX occurs when the UE 104 does not transmit any signal on a resource where the NE 102 expects to receive feedback, which may occur when the UE 104 is unaware of a scheduled transmission due to a missed DCI. The misinterpretation of DTX as NACK or other feedback errors may lead to NACK-to-ACK errors, which are described in further detail with respect to FIG. 2.

In the wireless communications system 100, the NE 102 may configure the UE 104 with multiple BWPs. A BWP is a contiguous set of physical RBs (PRBs) within a carrier bandwidth, where a PRB is a unit of frequency resources including a defined numerical quantity (e.g., number, amount) of subcarriers (e.g., 12 subcarriers) over a defined time duration (e.g., one slot). The UE 104 may be configured with multiple BWPs, but may have one active BWP at a given time for downlink reception and one active BWP for uplink transmission. BWP switching enables the UE 104 to adapt to varying traffic demands and channel conditions by switching between BWPs of different sizes and configurations. For example, the NE 102 may configure the UE 104 with the multiple BWPs via radio resource control (RRC) signaling. The RRC signaling may include a BWP configuration IE or other configuration information that indicates parameters for each BWP, such as a BWP identifier, a location and bandwidth of the BWP in the frequency domain, a subcarrier spacing, a cyclic prefix, and/or one or more CORESETs and search space sets for the BWP. The RRC signaling may also indicate an initial active BWP and a default BWP to which the UE 104 may revert (e.g., if one or more conditions are met, after a timer expires). Each BWP may include a subset of frequency resources within a frequency band. The UE 104 may monitor the initial active BWP for signaling from the NE 102, such as downlink control channels and/or downlink shared channels. For example, the UE 104 may monitor one or more CORESETs and search space sets configured for the initial active BWP to detect downlink control channels transmitted by the NE 102. The UE 104 may decode the downlink control channels to obtain scheduling information for downlink shared channels or other control commands. The UE 104 may receive downlink shared channels within the frequency resources of the initial active BWP based on the scheduling information provided in the downlink control channels.

In some cases, the NE 102 may transmit a downlink control channel to the UE 104 that indicates a BWP switch from an active BWP to a different configured BWP. For example, the NE 102 may include a BWP indicator field in the DCI carried by the downlink control channel. The BWP indicator field may indicate a BWP identifier corresponding to the target BWP to which the UE 104 is to switch. The BWP identifier may indicate one of the BWPs configured for the UE 104 via RRC signaling. In some cases, the BWP indicator field may be included in DCI formats that support BWP switching, such as DCI format 1_1 or DCI format 0_1 for downlink and uplink BWP switching, respectively. The size of the BWP indicator field may depend on the number of configured BWPs for the UE 104. For example, if the UE 104 is configured with up to four downlink BWPs, then the BWP indicator field may include two bits to indicate one of the four BWPs. The UE 104 may decode the BWP indicator field to determine the target BWP and initiate the BWP switch after a BWP switching delay, which may be a defined (e.g., predetermined, configured, preconfigured) time duration. The BWP switching delay is a time period during which the UE 104 transitions from the current active BWP to the target BWP. During the BWP switching delay, the UE 104 may not be expected to receive or transmit on either BWP. The UE 104 may switch to the indicated BWP to receive subsequent downlink control channels and/or downlink shared channels.

In some examples, DCI-based BWP switching enables relatively fast transitions (e.g., less than a threshold duration or time period), which may provide for the UE 104 to save energy by switching to a smaller BWP if a large bandwidth is no longer utilized or to efficiently handle bursty traffic by switching to a larger BWP if a small bandwidth is insufficient to serve the data burst. Bursty traffic refers to data traffic patterns characterized by intermittent periods of high data volume followed by periods of low or no data activity. If the NE 102 schedules a UE 104 with downlink data and simultaneously commands a BWP switch, then the reception of the corresponding HARQ-ACK feedback may be interpreted as confirmation that the UE 104 correctly decoded the DCI and has switched (e.g., or will switch) to the indicated BWP. Additionally, or alternatively, for uplink BWP switching, the NE 102 schedules a PUSCH transmission together with the uplink BWP switching command. Upon receiving the scheduled PUSCH, the NE 102 may assume that the UE 104 successfully decoded the DCI and has switched (e.g., or will switch) the BWP accordingly.

However, misalignment between the NE 102 and the UE 104 with respect to the active BWP of the UE 104 may occur, resulting in communication failure or inefficiency. For example, if the UE 104 misses a downlink control channel indicating a BWP switch, then the UE 104 may not switch to the indicated BWP, while the NE 102 may assume that the UE 104 successfully received the BWP switch indication. The misalignment may cause communication failures, missed signaling, or unnecessary power consumption due to the UE 104 monitoring CORESETs that the NE 102 is not using for transmission. Additionally, or alternatively, if the UE 104 begins monitoring a second CORESET immediately after switching to a second BWP, but the NE 102 is unaware that the UE 104 has switched, then the NE 102 may not transmit downlink control channels in the second CORESET, resulting in missed scheduling opportunities.

According to implementations described herein, one or more of the NEs 102 and the UEs 104 are operable to implement various aspects of the techniques described with reference to the present disclosure. The NEs 102 and the UEs 104 may implement a common CORESET configuration that spans multiple BWPs to address the misalignment between the NE 102 and the UE 104 regarding BWP switching and to improve reliability of downlink control channel reception. A common CORESET is a CORESET that is configured with the same time-frequency resources and parameters across multiple BWPs, enabling the UE 104 to monitor for downlink control channels in the same location regardless of a BWP that is currently active. For example, the NE 102 transmits signaling indicating CORESETs 108 to the UE 104, where the signaling indicating CORESETs 108 indicates a first CORESET and a second CORESET. The first CORESET is configured for both a first BWP and a second BWP, and the second CORESET is configured for the second BWP. The first CORESET serves as the common CORESET between the first BWP and the second BWP.

In some examples, the NE 102 transmits downlink control channels 110 to the UE 104, where the downlink control channels 110 include a first downlink control channel transmitted in the first CORESET that indicates to switch from the first BWP to the second BWP. Upon receiving the first downlink control channel, the UE 104 switches from the first BWP to the second BWP. Prior to transmission of feedback 112 in response to the first downlink control channel, the UE 104 refrains from monitoring the second CORESET for a second downlink control channel. During this period, the UE 104 continues to monitor at least a subset of the first CORESET, which serves as the common CORESET between the first BWP and the second BWP. The UE 104 transmits the feedback 112 in response to the first downlink control channel to the NE 102. After the UE 104 transmits the feedback 112, the UE 104 monitors both the first CORESET and the second CORESET for the second downlink control channel. Similarly, the NE 102 refrains from transmitting the second downlink control channel in the second CORESET prior to reception of the feedback 112, and transmits the second downlink control channel in at least one of the first CORESET or the second CORESET based on the feedback 112, enabling alignment between the NE 102 and the UE 104 regarding the active BWP and the CORESETs being monitored.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

FIG. 2 illustrates an example of a resource diagram 200 in accordance with aspects of the present disclosure. In some examples, the resource diagram 200 implements or is implemented by aspects of the wireless communications system 100. For example, the resource diagram 200 may be implemented by one or more UEs and/or NEs, which may be an example of NEs 102 and UEs 104, as described with reference to FIG. 1. The resource diagram 200 illustrates an example of a DTX-to-NACK in feedback.

In some examples, a UE may implement a DTX cycle. The DTX cycle is an example of a periodic pattern in which the UE alternates between active periods, during which the UE transmits signaling (e.g., feedback in response to downlink control channels and/or downlink shared channels), and inactive periods, during which the UE enters a low-power state and does not transmit signaling. In some cases, an NE may be unable to distinguish between a NACK, which indicates unsuccessful decoding of a downlink shared channel, and a DTX period during which a UE did not detect the corresponding downlink control channel. The ambiguity may lead to incorrect retransmission scheduling decisions at the NE. For example, if the NE receives a NACK, then the NE may schedule a retransmission of the downlink shared channel. However, if the UE did not detect the downlink control channel (during a DTX period, due to a weak channel, due to low quality received signal, or due to blocking, etc.), then the UE may not be expecting the retransmission, leading to resource inefficiency (e.g., (1) the NE may use similar PDCCH transmission parameters, as opposed to more conservative and/or reliable PDCCH transmission parameters, due to the NE expecting the UE not to decode the PDSCH correctly when the UE actually missed the DCI and/or PDCCH, (2) the NE may unnecessarily use larger aggregation levels for a PDCCH due to expecting the UE to have missed the DCI, while the UE was able to decode the PDCCH and obtain the DCI, but was not able to decode the PDSCH correctly) and potential communication failures. To address the ambiguity, the resource diagram 200 illustrates a HARQ-ACK codebook that includes two portions of feedback. A first portion of feedback includes ACK and/or DTX bits for downlink control channels, and a second portion includes ACK and/or NACK bits (e.g., A/N bits) for downlink shared channels. The HARQ-ACK codebook enables the NE to differentiate between ACK and DTX, eliminating the ambiguity in retransmission scheduling.

The resource diagram 200 includes an ACK 202-a, an ACK 202-b, and an ACK 202-c, which represent bits indicating successful reception and decoding of corresponding downlink control channels. The ACK 202-a, the ACK 202-b, and the ACK 202-c are positioned within the first portion of the codebook structure. Each ACK bit corresponds to a downlink control channel monitoring occasion in which the UE successfully detected and decoded a downlink control channel. The ordering of the ACK bits within the codebook may be based on the temporal order of the downlink control channel monitoring occasions, enabling the NE to correlate each ACK bit with a downlink control channel transmission. The resource diagram 200 also includes a DTX 204, which represents a discontinuous transmission indicator. The DTX 204 indicates that the UE did not detect a corresponding downlink control channel, enabling the NE to distinguish between a missed downlink control channel and an unsuccessful downlink shared channel decoding. The DTX 204 may be represented by a specific bit value (e.g., a NACK value) in the first portion of the codebook, where the NE interprets the NACK value in the first portion as a DTX indication rather than a decoding failure.

The resource diagram 200 further includes A/N bits for PDSCHs 206. The A/N bits for PDSCHs 206 form the second portion of the codebook structure and indicate whether the UE 104 successfully decoded the downlink shared channels scheduled by the corresponding downlink control channels. The number of A/N bits for PDSCHs 206 may correspond to the number of downlink control channels that schedule downlink shared channels with HARQ-ACK reporting enabled. In some cases, the A/N bits for PDSCHs 206 may include multiple bits per downlink shared channel, such as if the downlink shared channel includes multiple TBs or if code block group (CBG)-based feedback is enabled. The resource diagram 200 also includes padding 208, which represents additional bits appended to the codebook to achieve a target codebook size. The padding 208 may be used to align the codebook size with a configured or expected size at the NE. The padding 208 may include NACK values or other defined (e.g., configured, predetermined, preconfigured) bit values that the NE can determine and discard when processing the feedback.

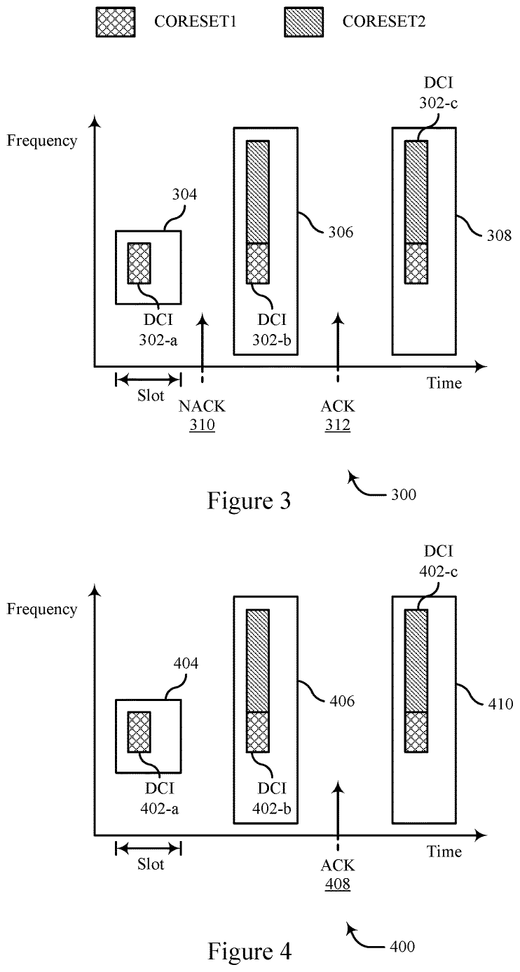

FIG. 3 illustrates an example of a transmission diagram 300 in accordance with aspects of the present disclosure. In some examples, the transmission diagram 300 implements or is implemented by aspects of the wireless communications system 100 and/or the resource diagram 200. For example, the transmission diagram 300 may be implemented by one or more UEs and/or NEs, which may be an example of NEs 102 and UEs 104, as described with reference to FIG. 1. The transmission diagram 300 illustrates an example of a common CORESET configuration for BWP switching indicated by a scheduling downlink control channel.

In some examples, an NE transmits signaling to a UE that configures the UE with at least one CORESET (e.g., CORESET1) for a first BWP (e.g., BWP1) and at least two CORESETs (e.g., CORESET1 and CORESET2) for a second BWP (e.g., BWP2). For example, the NE may transmit RRC signaling to the UE that includes a BWP configuration IE indicating parameters for each BWP, where the parameters include CORESET configurations for each BWP. The RRC signaling may indicate that the first CORESET is configured for both the first BWP and the second BWP, while the second CORESET is configured for the second BWP. The first CORESET is common between the two BWPs, where the first BWP and the second BWP overlap at least within the RBs of the first CORESET. The common CORESET provides the NE with the flexibility to schedule data or transmit control commands in a CORESET that the UE monitors, regardless of whether the UE has successfully switched to the target BWP. If the NE commands the UE to switch from the first BWP to the second BWP and schedules data transmission for the UE, then the NE continues scheduling the UE and/or transmitting DCI (e.g., including non-scheduling DCI) in the first CORESET within a search space set of the first CORESET until the NE confirms that the UE has switched to the second BWP.

The NE may transmit a DCI 302-a in a monitoring occasion 304 within a first CORESET (e.g., CORESET1). A monitoring occasion may span a slot in the time domain and any numerical quantity of frequency resources in the frequency domain within the respective CORESET. In some examples, the DCI 302-a may be a scheduling DCI that schedules a downlink shared channel (e.g., a PDSCH) and indicates a BWP switch from the first BWP to the second BWP. In some other examples, the DCI 302-a may be a non-scheduling DCI (e.g., a group-common DCI) that indicates the BWP switch without scheduling a downlink shared channel, which is described in further detail with respect to FIG. 4. The UE switches from the first BWP to the second BWP in response to the DCI 302-a that the NE transmits in the first CORESET. The UE does not monitor the second CORESET (e.g., even after completing the BWP switch) and monitors the first CORESET. The NE transmits a DCI 302-b in a monitoring occasion 306 within the first CORESET. The DCI 302-b may schedule a downlink shared channel within the frequency resources of the first BWP or within the overlapping RBs between the first BWP and the second BWP. In some cases, the NE may use the DCI 302-b to retransmit a previously scheduled downlink shared channel (e.g., a retransmission for a HARQ process for the DCI 302-a) or to schedule a new downlink shared channel for a different HARQ process. The NE transmits a DCI 302-c in a monitoring occasion 308 within the second CORESET (e.g., CORESET2). The monitoring occasion 304, the monitoring occasion 306, and the monitoring occasion 308 represent respective sets of time-frequency resources in which the UE monitors for downlink control channel candidates.

The UE transmits a NACK 310 in response to the DCI 302-a, indicating unsuccessful decoding of a downlink shared channel that the DCI 302-a schedules. In some examples, the NE may receive the NACK 310, but may be unable to distinguish whether the UE failed to decode the downlink shared channel or failed to decode the DCI 302-a. However, because the NE continues to schedule the UE in the common first CORESET, the NE can still communicate with the UE regardless of whether the UE has switched to the second BWP. The UE transmits an ACK 312 in response to a subsequent downlink shared channel that a downlink control channel received in the first CORESET schedules. The ACK 312 may be in response to a retransmission of the previously failed downlink shared channel (e.g., for the same HARQ process) or in response to a new downlink shared channel scheduled by the DCI 302-b. The UE starts monitoring both the first CORESET and the second CORESET in the second BWP (e.g., an entire BWP2 region) after transmitting the ACK 312 in response to a DCI received in the first CORESET with a BWP identifier indicating the second BWP (e.g., the DCI 302-b). The ACK 312 serves as confirmation to the NE that the UE has successfully decoded the DCI and has switched (e.g., or will switch) to the second BWP, enabling the NE to begin scheduling the UE using the full set of CORESETs configured for the second BWP. Thus, the NE starts scheduling the UE via downlink control channels in the second CORESET at least after receiving the ACK 312 (e.g., or multiple ACKs) in response to a previous scheduling command that indicated a BWP identifier of the second BWP.

In addition to the UE refraining from monitoring the second CORESET prior to transmitting the ACK 312, the NE may also adapt transmission behavior during the transition period. For example, the NE may communicate scheduled data within the first BWP if the first BWP is a subset of the second BWP. The NE may transmit the scheduled data within the RBs of the first CORESET in symbols other than the symbols allocated for search space sets of the first CORESET, or within an overlapped region of the first BWP and the second BWP. The NE transmits the scheduled data based on the first CORESET until the UE transmits the ACK 312 with respect to the first downlink control channel indicating the second BWP after a last downlink control channel indicating the first BWP. After the ACK 312, the NE can schedule the UE with data communication within the entire second BWP region.

In some examples, the NE configures the first CORESET with a duration of a first numerical quantity of symbols (e.g., six symbols, a duration W) in the first BWP. The first BWP may have a smaller bandwidth (e.g., fewer RBs) than the second BWP, and the first CORESET may have a longer duration (e.g., six symbols) in the first BWP to compensate for the limited frequency resources by providing more time resources for control channel transmission. If the UE has started monitoring both the first CORESET and the second CORESET in the second BWP, then the UE monitors the first CORESET with a different duration of a second numerical quantity of symbols (e.g., three symbols, a duration V). The second BWP, having a larger bandwidth with more RBs, may not utilize the extended duration because the larger frequency allocation provides sufficient resources for control channel transmission. In some other examples, after the UE completes the BWP switch, the UE starts monitoring the first CORESET with the duration that the NE configured for the second BWP (e.g., the duration V).

The NE may configure the first CORESET with a first configuration in the first BWP and a second configuration in the second BWP, where the first configuration and the second configuration may have one or more different parameters (e.g., duration, search space set periodicity, or other CORESET parameters). After the UE completes the BWP switch, and prior to transmitting the ACK 312, the UE monitors the first CORESET according to the CORESET configuration for the first BWP or, alternatively, for the second BWP. In some cases, the UE monitors the first CORESET for a limited configured or predetermined time after receiving the BWP switch command. For example, the UE may start a timer after receiving the BWP switch command, and the UE may refrain from monitoring the first CORESET after expiry of the timer. The NE may configure the timer duration (e.g., via RRC signaling), or the timer duration may be a defined (e.g., predetermined, configured, preconfigured) value. In some cases, the first CORESET is sufficient to be a subset of the CORESET as configured in the first BWP, such that the UE monitors at least a portion of the original CORESET resources in the second BWP.

In some cases, the NE transmits signaling to the UE that configures the UE with a first CORESET and a second CORESET for the first BWP, and with a third CORESET and a fourth CORESET for the second BWP. The first CORESET and the second CORESET define time-frequency resources within which the UE monitors for downlink control channels while operating on the first BWP. The third CORESET and the fourth CORESET define time-frequency resources within which the UE monitors for downlink control channels while operating on the second BWP. After switching to the second BWP and prior to transmitting the ACK 312, the UE monitors the first CORESET and refrains from monitoring the third CORESET and the fourth CORESET.

In some examples, the first CORESET may be one of a set of CORESETs configured for the first BWP, and the UE or the NE may determine which CORESET of the set to use as the common CORESET based on one or more criteria. For example, the UE and/or the NE may select the common CORESET with the largest size (e.g., the greatest number of RBs) among the set of CORESETs configured for the first BWP. Additionally, or alternatively, the UE and/or the NE may select the common CORESET that is explicitly configured for BWP switching purposes. Additionally, or alternatively, the UE and/or the NE may select the common CORESET with the greatest numerical quantity of overlapping RBs between the first BWP and the second BWP. In some cases, the first BWP and the second BWP have the same radio frequency center frequency, and BWP switching between the first BWP and the second BWP does not require radio frequency retuning. Radio frequency retuning refers to a process in which the UE adjusts radio frequency components, such as local oscillators, filters, and amplifiers, to operate at a different center frequency or frequency range. The absence of RF retuning simplifies the BWP switching process and enables the UE to begin monitoring the common CORESET in the second BWP without additional delay for frequency adjustment. In some examples, if the UE is configured with more than two BWPs (e.g., three BWPs), then for each BWP switching pair, the UE monitors the CORESETs of the smaller BWP of the pair after the BWP switch completes and prior to transmitting the ACK, ensuring that there is a common region of control resources that the NE can use to communicate with the UE.

In some examples, if the UE is configured with a common CORESET, then the UE may transmit feedback in response to a downlink shared channel scheduled by a downlink control channel (e.g., rather than feedback being associated with the downlink control channel). The UE refraining from monitoring a CORESET may include the UE not monitoring the CORESET, the UE skipping monitoring occasions for the CORESET, or the UE disabling search space sets configured for the CORESET.

FIG. 4 illustrates an example of a transmission diagram 400 in accordance with aspects of the present disclosure. In some examples, the transmission diagram 400 implements or is implemented by aspects of the wireless communications system 100, the resource diagram 200, and/or the transmission diagram 300. For example, the transmission diagram 400 may be implemented by one or more UEs and/or NEs, which may be an example of NEs 102 and UEs 104, as described with reference to FIG. 1. The transmission diagram 400 illustrates an example of a common CORESET configuration for BWP switching indicated by a non-scheduling downlink control channel.

In some cases, an NE transmits a DCI 402-a in a monitoring occasion 404 within a first CORESET (e.g., CORESET1). A monitoring occasion may span a slot in the time domain and any numerical quantity of frequency resources in the frequency domain within the respective CORESET. The DCI 402-a indicates a switch from a first downlink BWP (e.g., BWP1) to a second downlink BWP (e.g., BWP2) and is a non-scheduling DCI (e.g., in a downlink control channel that does not schedule a downlink shared channel). The first CORESET is configured for both the first BWP and the second BWP, and a second CORESET (e.g., CORESET2) is configured for the second BWP and not the first BWP, as described with reference to FIG. 3. After the UE switches from BWP1 to BWP2 in response to the DCI 402-a, the UE refrains from monitoring (e.g., does not monitor) the second CORESET (e.g., CORESET2) and monitors CORESET1. The UE refrains from monitoring CORESET2 until the UE transmits feedback in response to a downlink control channel received in CORESET1 with a BWP identifier indicating BWP2.

The NE transmits a DCI 402-b in a monitoring occasion 406 within CORESET1 in the BWP2. The DCI 402-b is a scheduling DCI with a BWP identifier indicating the BWP2. The UE transmits an ACK 408 in response to the DCI 402-b received in the CORESET1 with the BWP identifier that indicates the BWP2. The ACK 408 indicates successful decoding of the DCI 402-b and confirms to the NE that the UE has successfully switched to BWP2. After transmitting the ACK 408, the UE starts monitoring both CORESET1 and CORESET2 in the BWP2. The NE transmits a DCI 402-c in a monitoring occasion 410 within CORESET2 after the UE begins monitoring both CORESETs. The monitoring occasion 404, the monitoring occasion 406, and the monitoring occasion 410 represent respective sets of time-frequency resources in which the UE monitors for downlink control channel candidates.

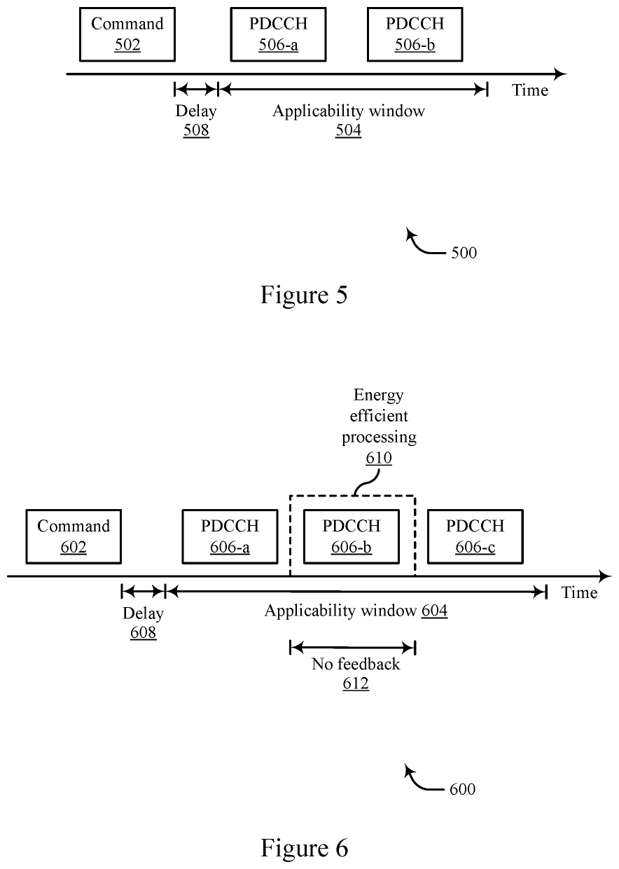

FIG. 5 illustrates an example of a transmission diagram 500 in accordance with aspects of the present disclosure. In some examples, the transmission diagram 500 implements or is implemented by aspects of the wireless communications system 100 and/or the resource diagram 200. For example, the transmission diagram 500 may be implemented by one or more UEs and/or NEs, which may be an example of NEs 102 and UEs 104, as described with reference to FIG. 1. The transmission diagram 500 illustrates an example of a downlink control channel triggering feedback for a downlink control channel.

In some examples, an NE transmits a command 502 to a UE that triggers feedback for the command 502 and/or one or more downlink control channels. The command 502 may be a downlink control channel (e.g., a first PDCCH, referred to as PDCCH1) or a WUS command that triggers feedback for at least one subsequent downlink control channel (e.g., a second PDCCH, referred to as PDCCH2). In some examples, the WUS may be a downlink WUS that enables downlink control channel monitoring and triggers feedback for the downlink WUS or for subsequent downlink control channels. Upon reception of the command 502 triggering downlink control channel feedback, the UE determines a feedback resource in the uplink and provides feedback in response to the subsequent downlink control channels (e.g., PDCCH2s). For example, the UE determines a feedback resource (e.g., an uplink control channel resource) for the WUS using the content of the WUS or a transmission time of the WUS or for the downlink control channels for which a WUS triggers feedback for PDCCH. For example, the UE may determine the feedback resource according to a time domain offset from a last symbol of the WUS or from a slot in which the WUS is transmitted. The WUS may include a field or a sequence-related attribute (e.g., cyclic shift or a mask) that indicates the time domain offset or an uplink control channel resource index for the feedback resource. Additionally, or alternatively, the UE may determine the feedback resource based on a rule, such as selecting a first available uplink slot after the WUS that is at least a configured number of slots after the slot including the WUS. Additionally, or alternatively, the NE may define an uplink control channel resource (e.g., a PUCCH resource) or feedback resource for each instance of WUS monitoring (e.g., a periodic uplink control channel resource with a periodicity determined by a WUS monitoring periodicity). Additionally, or alternatively, if the command 502 is a downlink control channel (e.g., PDCCH1), then the UE may determine the feedback resource from a field in the command 502 (e.g., PDCCH1) that indicates an uplink control channel resource index or a time domain offset for the feedback transmission.

The feedback may indicate one or more combinations of DCI decoding status and downlink shared channel decoding status. For example, the feedback may indicate successful DCI decoding and successful downlink shared channel decoding (e.g., a feedback pair including two bits with values of (1, 1)), successful DCI decoding and unsuccessful downlink shared channel decoding (e.g., a feedback pair including two bits with values of (1, 0)), or unsuccessful DCI decoding and unsuccessful downlink shared channel decoding (e.g., a feedback pair including two bits with values of (0, 0)). A feedback pair of unsuccessful DCI decoding and successful downlink shared channel decoding (e.g., (0, 1)) may not be valid because the UE cannot successfully decode a downlink shared channel without first successfully decoding the DCI that schedules the downlink shared channel. The DCI may be carried by a downlink control channel and may include scheduling information, resource assignments, and/or other control information for the UE, as described with reference to FIGS. 1 and 2.

In some examples, the command 502 (e.g., PDCCH1) does not schedule uplink or downlink data, such as a PDSCH and/or a PUSCH. The command 502 may have a smaller DCI payload compared to a DCI that schedules uplink or downlink data. Additionally, or alternatively, the command 502 may include a DCI field for each group of UEs, where each DCI field indicates whether the UEs in that group are to provide downlink control channel feedback. The NE may utilize the command 502 to trigger downlink control channel feedback for periodic traffic with jitter and/or if a group-common DCI switches a BWP or indicates other functionalities.

The transmission diagram 500 includes an applicability window 504 that defines a time period and/or frequency during which the UE monitors for and provides feedback for downlink control channels that the UE receives within the applicability window 504 (e.g., the PDCCH 506-a and/or the PDCCH 506-b, PDCCH2s). In some cases, the applicability window 504 may begin after a delay 508 from the command 502. The delay 508 may be a configured or predetermined time duration (e.g., offset) between the command 502 and the start of the applicability window 504. Within the applicability window 504, the NE transmits a PDCCH 506-a and a PDCCH 506-b to the UE. The PDCCH 506-a and the PDCCH 506-b are examples of downlink control channels (e.g., PDCCH2s) for which the UE provides feedback in response to the command 502.

In some cases, a field in the command 502 (e.g., PDCCH1) may indicate a duration, start time, and/or end time of the applicability window 504. The applicability window 504 may span a numerical quantity of slots (e.g., W slots) from the slot in which the NE transmits the command 502, or from the slot in which the NE transmits a last repetition of the command 502. The NE may predetermine, configure, or indicate (e.g., in the command 502) the numerical quantity of slots W. The time window duration may be a multiple of a search space set periodicity. For example, if the NE triggers downlink control channel feedback for downlink control channel candidates of a CORESET linked to a search space periodicity, then the NE may indicate (e.g., in the command 502) for how many periods of the search space set the UE is to provide feedback for the downlink control channels in the search space set.

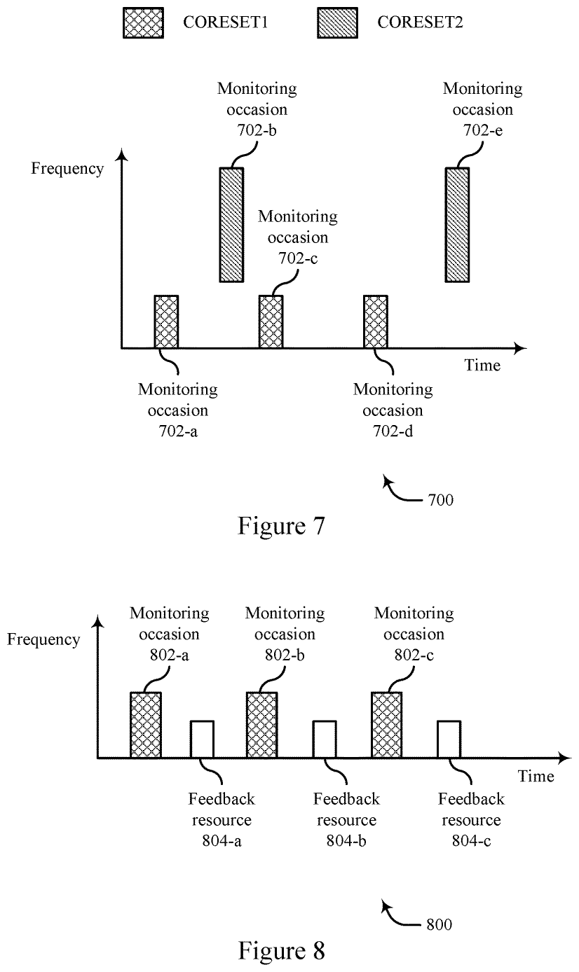

In some examples, the applicability window 504 may include a frequency window in addition to, or instead of, a time window. The NE and/or UE may predetermine, configure, or indicate a starting RB of the frequency window, a frequency length, and/or an end frequency (e.g., a last RB). The frequency window may be a CORESET that the NE indicates or configures using a CORESET identifier. The UE may provide feedback for downlink control channels that the UE receives in a CORESET with the indicated or configured CORESET identifier. Additionally, or alternatively, the NE may indicate or configure the UE with a search space set linked to the CORESET, where the frequency window applies within the time-domain symbols of the search space set. If more than one search space set links to the CORESET, then the UE may separately associate feedback bits for downlink control channels (e.g., PDCCH2s) that the UE receives within each search space set with a feedback codebook. For example, the NE may configure the UE with two CORESETs, and the UE may monitor each CORESET in downlink control channel monitoring occasions of a search space. The UE may provide feedback for downlink control channels that the UE receives in one of the CORESETs (e.g., a first CORESET) and not the other CORESET (e.g., a second CORESET), which is described in further detail with respect to FIG. 7.

The UE may bundle together feedback for downlink control channels (e.g., PDCCH2s) for a single UE that the UE receives within a window of time and/or a window of frequency (e.g., the applicability window 504). Additionally, or alternatively, the UE may bundle together feedback for downlink control channels that the UE receives within a search space set linked to a CORESET. A DCI field in the command 502 (e.g., PDCCH1) may indicate that the UE is to provide downlink control channel feedback for one or more DCI formats or blocks. In some cases, such as for a two-stage DCI, a first stage may indicate the DCI format for a second stage, and the feedback may apply to the second stage. An indication (e.g., a downlink control channel) may indicate a format or aggregation level for a window of time. For example, the aggregation level may define a reliability or robustness of downlink control channel transmissions within the window of time. The NE may indicate that downlink control channels transmitted with a defined aggregation level (e.g., aggregation level 4 or higher) within the applicability window 504 are subject to feedback, while downlink control channels transmitted with a lower aggregation level may not have feedback. Additionally, or alternatively, the indication may specify that the UE is to provide feedback for downlink control channels of a DCI format (e.g., DCI format 1_1 for downlink scheduling or DCI format 0_1 for uplink scheduling) received within the window of time.

In some examples, the NE may configure the UE to provide downlink control channel feedback whenever a defined DCI field value has changed within a time or frequency window and/or has changed from a last received DCI. For example, if a BWP identifier has changed from the last received DCI, then the UE may provide feedback. The UE may refrain from providing feedback for downlink control channels that the NE transmits in a reduced energy or reduced processing state (e.g., an energy efficient processing state), which is described in further detail with respect to FIG. 6.

In some examples, if the NE repeats a downlink control channel multiple times (e.g., a downlink control channel reception includes two or more downlink control channel candidates from two or more search space sets), then the UE may provide a single feedback for the repeated downlink control channel. In some cases, if the NE transmits one or more repetitions of the downlink control channel outside of the time and/or frequency window for downlink control channel feedback, then the UE may not consider the downlink control channel for providing feedback. In some other cases, the UE may consider the downlink control channel for providing feedback, such as if the DCI includes one or more assignment index fields for downlink control channel feedback.

In some examples, the UE determines the feedback resource from a field in the command 502 (e.g., PDCCH1). The UE determines the resource (e.g., an uplink control channel resource or an uplink shared channel resource) using a time distance from a last symbol or a slot of the command 502, where the UE calculates the time distance from the field in the command 502 or from a field in a subsequent downlink control channel (e.g., PDCCH2). The field may be the same as or different from a PDSCH-to-HARQ field. The NE configures an uplink control channel resource according to a reference search space monitoring periodicity, where the UE transmits feedback before a next search space monitoring occasion so that the NE can process an ACK and repeat or retransmit the downlink control channel. The reference search space may be the search space that the NE uses for the subsequent downlink control channels (e.g., PDCCH2s, the PDCCH 506-a and/or the PDCCH 506-b). The NE configures the resource to occur no later than a time before the next downlink control channel monitoring occasion or search space for the subsequent downlink control channels. The NE configures or predetermines the time (e.g., one slot prior to the monitoring occasion or search space).

In some examples, the NE configures the feedback resource to be common for subsequent downlink control channels (e.g., PDCCH2s) that the UE receives within a time or frequency window (e.g., a search space set within a CORESET, the applicability window 504). The UE provides a separate feedback bit for every subsequent downlink control channel, and the UE constructs a codebook (e.g., similar to a HARQ-ACK codebook) from the individual feedback bits. Additionally, or alternatively, the UE bundles together the feedback for the subsequent downlink control channels received within the time or frequency window and provides a single bit of feedback.

In some cases, the NE configures a feedback resource for a set of DCI formats (e.g., non-scheduling DCIs and uplink scheduling DCIs). The NE determines the feedback resource periodicity from a search space set periodicity within a CORESET. The NE configures (e.g., as part of PUCCH resource configuration) or indicates a time offset with respect to the search space set (e.g., a first symbol, a last symbol, or a next slot after the search space set). The NE positions the feedback resource for downlink control channels received in a CORESET relative to the CORESET in the time domain, which is described in further detail with respect to FIG. 8.

In some examples, the NE transmits a medium access control (MAC) control element (MAC-CE) or a higher-layer indication to enable a periodic uplink control channel resource, and the UE transmits a feedback codebook prior to the resource (e.g., not later than a numerical quantity of symbols, X, or slots prior to a next upcoming uplink control channel occasion for the downlink control channel feedback) in the resource. In some cases, the UE determines the feedback resource from a field in a subsequent downlink control channel (e.g., a second PDCCH, PDCCH2, PDCCH 506-a, and/or PDCCH 506-b). The UE may use a same resource for HARQ-ACK as for a downlink scheduling DCI. In some cases, a field in a non-scheduling DCI indicates a resource for feedback for the downlink control channel. Additionally, or alternatively, the UE determines the feedback resource according to a rule. For example, the rule indicates that the feedback resource is a first available uplink slot after the slot in which the NE transmits the command 502.

In some examples, if the NE enables feedback for subsequent downlink control channels (e.g., subsequent PDCCHs, PDCCH2s, the PDCCH 506-a, the PDCCH 506-b), then the UE multiplexes feedback for the subsequent downlink control channels in a feedback codebook. Each DCI (e.g., a downlink assignment, an uplink grant, or a group-common or non-scheduling DCI) that the NE transmits in a time and/or frequency window or in a group of DCIs (e.g., each group may include up to a numerical quantity, W, of DCIs, such as 16 DCIs) includes an assignment index. For example, in a time window, the UE may receive three DCIs, including one downlink DCI (e.g., having an assignment index of 1), one uplink DCI (e.g., having an assignment index of 2), and one group-common DCI (e.g., having an assignment index of 3). The UE multiplexes the three feedback bits in a feedback codebook.

In some examples, the UE multiplexes feedback for subsequent downlink control channels (e.g., subsequent PDCCHs, PDCCH2s) in a HARQ-ACK codebook, where the UE multiplexes together the feedback for the downlink shared channel that the subsequent downlink control channel schedules and the feedback for the downlink control channel. For each DAI or assignment index, the feedback includes HARQ-ACK feedback for the downlink shared channel and feedback for the downlink control channel.

In some cases, a DCI field in a subsequent downlink control channel (e.g., a subsequent PDCCH, PDCCH2) indicates whether the UE provides feedback for the downlink control channel. The field may be similar to a total DAI field (e.g., V_{DAI,total,PDSCH}). The NE defines a total DAI counter for downlink control channel feedback (e.g., V_{DAI,total,PDCCH}) in addition to the total DAI counter for a number of DCIs. The UE may provide feedback for each downlink control channel or DCI that includes a V_{DAI,total,PDCCH} field. For example, the NE may transmit four downlink control channels or DCIs to the UE, including DCI1, DCI2, DCI3, and DCI4. DCI1, DCI3, and DCI4 may include the V_{DAI,total,PDCCH} field, whereas DCI2 may not include the VDAL, total, PDCCH field. The UE may provide feedback for DCI1, DCI3, and DCI4, and may not provide feedback for DCI2. Having an additional V_{DAI,total,PDCCH} field may distinguish between DCI misdetection and unsuccessful downlink shared channel decoding. Because some DCIs in the codebook are non-scheduling DCIs or uplink DCIs, the additional parameter is useful.

If the NE enables feedback for subsequent downlink control channels (e.g., subsequent PDCCHs, PDCCH2s), then the UE multiplexes feedback for the subsequent downlink control channels in a HARQ-ACK codebook. The UE multiplexes together the feedback for the downlink shared channel that the subsequent downlink control channel schedules and the feedback for the downlink control channel. For each DAI, the feedback includes HARQ-ACK feedback for the downlink shared channel and feedback for the downlink control channel for a DCI scheduling one or more downlink shared channels, or feedback for the downlink control channel for a DCI scheduling one or more uplink shared channels.

In some examples, the UE uses different feedback codebooks for downlink scheduling DCIs and for non-scheduling DCIs and uplink DCIs. If the UE uses different feedback codebooks for the different DCIs, then the downlink scheduling DCIs do not include an additional V_{DAI,total,PDCCH} parameter. The NE includes a total DAI parameter (e.g., V_{DAI,total,PDCCH}) for non-scheduling DCIs and uplink DCIs. However, the total DAI parameter for downlink scheduling DCIs and the total DAI parameter for non-scheduling DCIs and uplink DCIs may be different. The NE may track two total DAI values at a time for the UE.

In some examples, the UE detects a DCI and determines if the DCI is a downlink scheduling DCI. If the DCI is a downlink scheduling DCI, then the UE determines a first HARQ-ACK codebook, reads a total DAI parameter in the DCI, decodes the downlink shared channel, provides an ACK or NACK from the downlink shared channel decoding result, and multiplexes the HARQ-ACK bit in the first HARQ-ACK codebook. If the DCI is not a downlink scheduling DCI, then the UE determines a second HARQ-ACK codebook, reads a total DAI parameter in the DCI, provides an ACK, and multiplexes the HARQ-ACK bit in the second HARQ-ACK codebook.

In some examples, the NE does not expect the UE to construct a HARQ-ACK codebook for DCIs or DCI formats where some of the DCIs or DCI formats result in feedback for the downlink control channel and some of them do not result in feedback. In other words, a HARQ-ACK codebook either includes downlink control channel feedback for every DCI for which the UE provides HARQ-ACK feedback, or the HARQ-ACK codebook does not have downlink control channel feedback for any DCI for which the UE provides HARQ-ACK feedback.

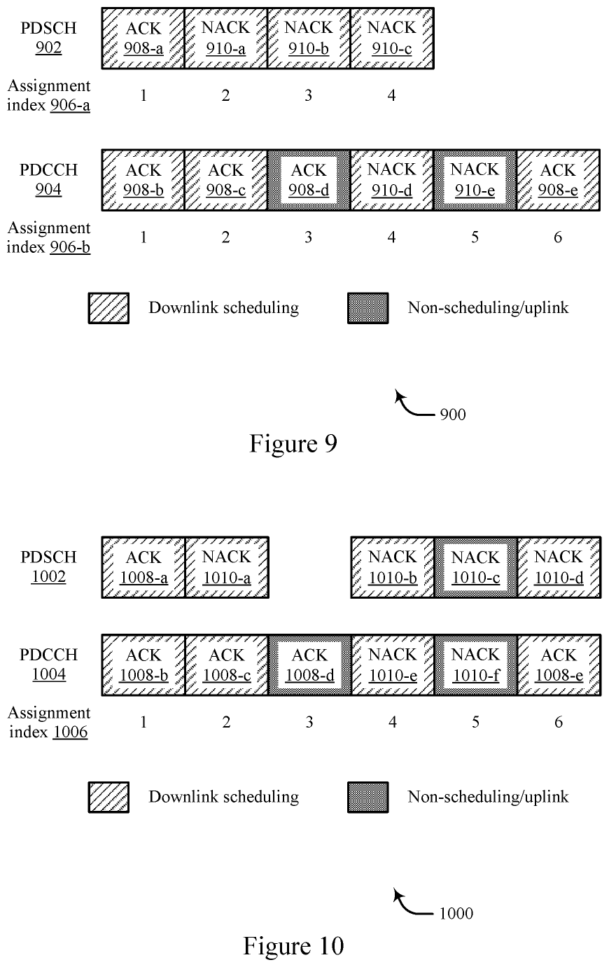

In some examples, V_{DAI,total,PDCCH} is larger than V_{DAI,total,PDSCH} because V_{DAI,total,PDCCH} tracks uplink DCIs or non-scheduling DCIs, such as group-common DCIs. Separate feedback bits for downlink control channels and downlink shared channels using two total DAI parameters (e.g., DCI fields), where one tracks DCIs and one tracks downlink shared channels, distinguish between DCI misdetection and NACK for the downlink shared channel and save feedback overhead, which is described in further detail with respect to FIG. 9. Separate feedback bits for downlink control channels and downlink shared channels using a single total DAI field save bits in the DCI, but may result in more feedback overhead. For example, if the UE does not detect the DCI, then the UE may not know if the DCI was a scheduling or a non-scheduling DCI. The UE may infer that no HARQ-ACK bit is used for a total DAI value if the UE has decoded the DCI and understood that the DCI is not a downlink scheduling DCI, which is described in further detail with respect to FIG. 10.

In some examples, the NE configures the UE to monitor a two-stage DCI for receiving control commands from the NE, where a first stage indicates one or more control attributes of a second stage (e.g., possible aggregation levels, a number of downlink control channel candidates, time-frequency resources). The NE transmits some downlink control channels using a single-stage DCI, while the NE transmits other downlink control channels following a two-stage DCI framework. If the NE configures or indicates the UE to provide feedback for a downlink control channel with a two-stage DCI, then the UE provides feedback for both DCI stages. If the UE decodes both stages correctly, then the UE transmits an ACK. Otherwise, the UE transmits a NACK. In some examples, the UE provides feedback per DCI stage to help the NE determine the reason for misdetection and adjust downlink control channel transmission parameters for each of the DCI stages.

In some examples, the NE provides an assignment index in the first stage DCI. If the UE provides feedback for each DCI stage (e.g., one bit for the first stage DCI and one bit for the second stage DCI), then the UE forms a feedback codebook using the knowledge that the DCI is a two-stage DCI and using the one assignment index indicated in the second stage DCI. For example, the NE may transmit four DCIs, including a DCI1 that is a single-stage DCI, a DCI2 that is a two-stage DCI, a DCI3 that is a two-stage DCI, and a DCI4 that is a single-stage DCI. The UE may receive DCI1, DCI2, and DCI4, and may miss DCI3. The downlink control channel feedback codebook may be {1, (1, 1), (0, 0), 1}.

If the NE indicates the second stage via a downlink shared channel, then the UE may provide feedback for the first stage because the UE will provide another feedback for the downlink shared channel that carries the second stage. In some cases, the UE may include the feedback for the downlink shared channel and the feedback for the downlink control channel in different codebooks. If the NE disables or postpones feedback for the downlink shared channel, or if the NE separately encodes and multiplexes the second stage DCI into the downlink shared channel, then the UE may include the feedback for the second stage separate from the downlink shared channel that carries the second stage.

In some examples, for power saving purposes or for reducing feedback overhead, the UE may transmit downlink control channel feedback when the feedback is a NACK. The UE may perform the transmission if there is a single downlink control channel to provide feedback for. For a feedback codebook, the UE performing the transmission if there is a single downlink control channel to provide the feedback for may not be efficient. Additionally, or alternatively, to reduce feedback overhead, the UE may bundle the feedback for one or more of the downlink control channels. For example, the UE may divide the time or frequency window (e.g., the applicability window 504) into sub-windows, and the UE may bundle feedback for DCIs received in each sub-window. Additionally, or alternatively, the UE may perform bundling using an assignment index (e.g., V_{DAI,total,PDCCH}). For example, if a maximum configured value for V_{DAI,total,PDCCH} is 16, then the UE may bundle the feedback for DCIs having V_{DAI,total,PDCCH} values of 1 through 4 into one bit, bundle the feedback for DCIs having V_{DAI,total,PDCCH} values of 5 through 8 into another bit, and so on. The NE may configure or indicate sub-window determination parameters (e.g., a number of sub-windows), such as via the command 502.

In some examples, the UE may report back to the NE an active BWP of the UE. The reporting may address the DTX-to-NACK error, as described with reference to FIGS. 1 and 2. The NE may order the UE to indicate a current or future active BWP (e.g., within a time duration, including after a next numerical quantity X of slots). The NE may configure or indicate the numerical quantity, X (e.g., in the DCI). The NE may configure or indicate whether the UE reports an uplink BWP and/or a downlink BWP. Additionally, or alternatively, the NE may configure the UE to report to the NE once the UE receives a downlink and/or uplink BWP switch command or when the UE changes the BWP.

In some examples, the UE may use the same resource for UE reporting as a HARQ-ACK resource. The UE may use a resource in a slot that the DCI indicates (e.g., when the DCI performs BWP switching and also schedules data) for providing HARQ-ACK. The UE may use a resource in slot n when the NE transmits the BWP report trigger in slot 0, where n is greater than a value NO, NO is a predetermined or configured value, and n is a first slot in which the UE provides a HARQ-ACK codebook after slot NO. Slot n may occur sufficiently earlier (e.g., by a predetermined number of slots or time, such as at least two slots) than the slot that the DCI indicates for providing HARQ-ACK. Otherwise, the UE may transmit the BWP report in the same HARQ-ACK codebook that the UE uses for the downlink shared channel scheduled by the DCI. In some other examples, the UE may use a separate (e.g., different, unique) uplink control channel resource for UE reporting than the HARQ-ACK resource.

For uplink BWP switching, the UE may report the uplink BWP identifier in a first upcoming HARQ-ACK codebook that is at least in a next slot of the slot in which the NE indicates the uplink BWP switch, or in a first available uplink slot after the UE completes the BWP switch (e.g., after a BWP switch delay that indicates the time needed for BWP switching). The NE may configure or enable the reporting for UEs in good channel conditions (e.g., greater than a threshold channel quality), as the UEs may utilize a relatively small amount of uplink resources (e.g., less than a threshold numerical quantity of time-frequency resources for uplink transmission).

In some examples, to ensure the NE receives the feedback (e.g., for the downlink control channel and/or for the downlink shared channel) that the UE transmits, the NE may trigger a more reliable uplink control channel if the NE commands a BWP switch. For example, the NE may increase the reliability of the uplink control channel by configuring PUCCH repetitions, reducing the PUCCH coding rate, and/or selecting a HARQ-ACK codebook type that provides improved error protection. Additionally, or alternatively, the NE may configure the UE with multiple (e.g., two or more) uplink control channel configurations having different reliability levels and dynamically select a more reliable configuration when commanding a BWP switch. The NE may indicate an uplink control channel configuration index in the DCI. For example, the NE may configure the UE with two uplink control channel configurations. A first uplink control channel configuration may include no uplink control channel repetition, a normal uplink control channel coding rate (e.g., a coding rate that is greater than or equal to a threshold coding rate), and a maximum feedback codebook size (e.g., for HARQ-ACK feedback or downlink control channel feedback). A second uplink control channel configuration may include three uplink control channel repetitions, a lower than normal uplink control channel coding rate (e.g., a coding rate that is less than the threshold coding rate), and a smaller maximum feedback codebook size (e.g., for HARQ-ACK feedback or downlink control channel feedback).

The downlink control channel (e.g., the command 502) may indicate enhanced uplink control channel reliability, such as an uplink control channel repetition number, using a lower code rate for the uplink control channel, or a special HARQ-ACK codebook. If the UE determines to use enhanced uplink control channel reliability, then the NE may apply scheduling limitations or criteria. For example, the NE may not bundle HARQ feedback or downlink control channel feedback with other feedback to help the NE determine if the UE has detected a DCI. Additionally, or alternatively, the NE may keep a HARQ or feedback codebook size small. Additionally, or alternatively, the NE may implement a HARQ-ACK or feedback codebook (e.g., that supports single-layer transmissions) to reduce HARQ payload and increase reliability accordingly.

Instead of the NE explicitly indicating the uplink control channel configuration index in the DCI (e.g., of the command 502 or a subsequent downlink control channel), a field in the DCI may implicitly indicate the uplink control channel configuration index. For example, if a BWP identifier changes from a previous (e.g., earlier, preceding) DCI or if the DCI command indicates a BWP change, then the BWP-switching DCI may trigger enhanced uplink control channel reliability. The NE may configure the UE with two uplink control channel reliability configurations. A first uplink control channel configuration (e.g., a default configuration) may have no uplink control channel repetition and may use a larger code rate. A second uplink control channel configuration (e.g., a configuration that a BWP-switching DCI triggers) may have uplink control channel repetition and may use a smaller code rate.

In some examples, the NE schedules a UE with data transmission and BWP switching. The NE assigns an ACK or NACK resource for the data transmission. If the NE does not receive the ACK or NACK, then the NE may transmit a downlink control channel triggering downlink control channel feedback, a BWP identifier report request, or downlink control channel repetition. The NE may indicate the resource for the downlink control channel feedback or BWP identifier report, or the UE may determine the resource using a rule.

The UE and/or the NE may apply priority handling for downlink control channel feedback (e.g., for overlap handling, for multiplexing HARQ ACK or NACK, or for bundling). For example, for time and/or frequency domain overlap of multiple uplink signals, the UE may treat HARQ-ACK feedback and feedback for the downlink control channel differently. The UE may drop the feedback for the downlink shared channel, but may multiplex or postpone the feedback for the downlink control channel. Additionally, or alternatively, the UE may postpone the feedback for the downlink shared channel, but may multiplex the feedback for the downlink control channel. Additionally, or alternatively, the NE may postpone the feedback for the downlink shared channel and feedback for the downlink control channel separately.

If the NE receives a NACK, then the NE may schedule data via a DCI that the NE transmits in a common CORESET across BWPs. The NE may limit the scheduled data to within a smaller of the two BWPs. In some examples, if a UE detects a DCI format indicating an active uplink BWP change for a cell, then the UE may not receive or transmit in the cell during a time duration from the end of a W^{th} symbol (e.g., where W is greater than or equal to a CORESET duration) of a slot where the UE receives the downlink control channel that includes the DCI format in the scheduling cell until the beginning of a slot that a slot offset value of a time domain resource assignment field in the DCI format indicates.

FIG. 6 illustrates an example of a transmission diagram 600 in accordance with aspects of the present disclosure. In some examples, the transmission diagram 600 implements or is implemented by aspects of the wireless communications system 100, the resource diagram 200, and/or the transmission diagram 500. For example, the transmission diagram 600 may be implemented by one or more UEs and/or NEs, which may be an example of NEs 102 and UEs 104, as described with reference to FIG. 1. The transmission diagram 600 illustrates an example of feedback triggering for downlink control channels with an energy efficient processing window.

In some cases, an NE transmits a command 602 that triggers feedback for a set of downlink control channels, as described with reference to FIG. 5. A delay 608 occurs between the command 602 and the start of an applicability window 604. The applicability window 604 defines a time period during which the UE monitors for and provides feedback associated with downlink control channels received within the applicability window 604. Within the applicability window 604, the NE transmits a PDCCH 606-a, a PDCCH 606-b, and a PDCCH 606-c. The transmission diagram 600 also includes an energy efficient processing window 610, which includes the PDCCH 606-b. The energy efficient processing window 610 represents a reduced processing state during which the UE operates with reduced power consumption.

The energy efficient processing window 610 may be a state in which the UE reduces processing and/or power consumption. For example, the energy efficient processing window 610 may be after a period during which the UE has not received any downlink control channel transmissions. In some examples, the UE may gradually transition into the energy efficient processing window 610 and may gradually wake up upon receiving a subsequent downlink control channel. A time period 612 is associated with the energy efficient processing window 610 and indicates a duration during which no feedback is provided by the UE for downlink control channels received within the energy efficient processing window 610. The UE may refrain from providing feedback for downlink control channels received within the energy efficient processing window 610 because providing feedback utilizes additional power, which is contrary to the purpose of the reduced processing state. The PDCCH 606-a and the PDCCH 606-c are transmitted outside of the energy efficient processing window 610, and the UE provides feedback for the PDCCH 606-a and the PDCCH 606-c.

FIG. 7 illustrates an example of a transmission diagram 700 in accordance with aspects of the present disclosure. In some examples, the transmission diagram 700 implements or is implemented by aspects of the wireless communications system 100, the resource diagram 200, the transmission diagram 500, and/or the transmission diagram 600. For example, the transmission diagram 700 may be implemented by one or more UEs and/or NEs, which may be an example of NEs 102 and UEs 104, as described with reference to FIG. 1. The transmission diagram 700 illustrates an example of downlink control channel monitoring occasions associated with multiple CORESETs (e.g., CORESET1 and CORESET2).

In some cases, the transmission diagram 700 includes a monitoring occasion 702-a at a first time location, a monitoring occasion 702-b at a second time location (e.g., and at a higher frequency), a monitoring occasion 702-c at a third time location, a monitoring occasion 702-d at a fourth time location, and/or a monitoring occasion 702-e at a fifth time location (e.g., and at the higher frequency). The monitoring occasion 702-a, the monitoring occasion 702-c, and the monitoring occasion 702-d may be within CORESET1, while the monitoring occasion 702-b and the monitoring occasion 702-e may be within CORESET2.

The transmission diagram 700 illustrates how monitoring occasions for different CORESETs may be distributed across time and frequency resources. In some examples, the UE may provide feedback for downlink control channels received in one of the CORESETs (e.g., CORESET1) and not the other CORESET (e.g., CORESET2), based on an indication from the NE. For example, the NE may indicate a CORESET identifier or a search space set identifier in a command (e.g., the command 502 or the command 602, as described with reference to FIGS. 5 and 6), and the UE may provide feedback for downlink control channels received in the indicated CORESET or search space set. If more than one search space set is linked to a CORESET, then the UE may separately associate feedback bits for downlink control channels received within each search space set with a feedback codebook.

FIG. 8 illustrates an example of a transmission diagram 800 in accordance with aspects of the present disclosure. In some examples, the transmission diagram 800 implements or is implemented by aspects of the wireless communications system 100, the resource diagram 200, the transmission diagram 500, the transmission diagram 600, and/or the transmission diagram 700. For example, the transmission diagram 800 may be implemented by one or more UEs and/or NEs, which may be an example of NEs 102 and UEs 104, as described with reference to FIG. 1. The transmission diagram 800 illustrates an example of a relationship between monitoring occasions and corresponding feedback resources.

In some cases, the transmission diagram 800 includes a monitoring occasion 802-a at a first time location at a higher frequency and a feedback resource 804-a at a lower frequency following the monitoring occasion 802-a in time. Additionally, or alternatively, the transmission diagram 800 includes a monitoring occasion 802-b at a second time location (e.g., after the first time location of the monitoring occasion 802-a) at a higher frequency and a feedback resource 804-b at a lower frequency following the monitoring occasion 802-b in time. Additionally, or alternatively, the transmission diagram 800 includes a monitoring occasion 802-c at a third time location (e.g., after the first time location of the monitoring occasion 802-a and the second time location of the monitoring occasion 802-b) at a higher frequency and a feedback resource 804-c at a lower frequency following the monitoring occasion 802-c in time.

In some examples, the NE may configure the feedback resources (e.g., the feedback resource 804-a, the feedback resource 804-b, the feedback resource 804-c) based on a periodicity associated with a reference search space set linked to a CORESET. The NE may configure or indicate a time offset with respect to the search space set (e.g., a first symbol, a last symbol, or a next slot after the search space set) for positioning the feedback resources relative to the monitoring occasions. In some examples, the NE may configure the feedback resource to occur no later than a defined time before a next downlink control channel monitoring occasion or search space for subsequent downlink control channels, enabling the NE to process the feedback and repeat or retransmit a downlink control channel. In some examples, the NE may transmit a MAC-CE or a higher-layer indication to enable a periodic uplink control channel resource, and the UE may transmit a feedback codebook in the resource prior to a next upcoming uplink control channel occasion for the downlink control channel feedback.

FIG. 9 illustrates an example of a transmission diagram 900 in accordance with aspects of the present disclosure. In some examples, the transmission diagram 900 implements or is implemented by aspects of the wireless communications system 100, the resource diagram 200, the transmission diagram 500, the transmission diagram 600, the transmission diagram 700, and/or the transmission diagram 800. For example, the transmission diagram 900 may be implemented by one or more UEs and/or NEs, which may be an example of NEs 102 and UEs 104, as described with reference to FIG. 1. The transmission diagram 900 illustrates an example of separate assignment indexes for tracking feedback associated with downlink shared channels and downlink control channels.

In some cases, the transmission diagram 900 includes one or more PDSCHs 902 that are scheduled by one or more PDCCHs 904, along with corresponding assignment indexes and feedback. In some cases, there may be four PDSCHs 902, such that an assignment index 906-a tracking the PDSCHs 902 may have values 1, 2, 3, and 4. The feedback for the PDSCHs 902 may include an ACK 908-a, a NACK 910-a, a NACK 910-b, and a NACK 910-c, respectively. In some cases, there may be six PDCCHs 904, such that an assignment index 906-b tracking the PDCCHs 904 may have values 1, 2, 3, 4, 5, and 6. The feedback for the PDCCHs 904 may include an ACK 908-b, an ACK 908-c, an ACK 908-d, a NACK 910-d, a NACK 910-e, and an ACK 908-e, respectively. The transmission diagram 900 uses separate assignment indexes, including the assignment index 906-a and the assignment index 906-b for the PDSCH 902 and the PDCCH 904, respectively. The separate assignment indices enable the UE to track feedback for downlink shared channels and downlink control channels independently.

In some examples, the assignment index 906-b (e.g., a total DAI for PDCCH tracking, V_{DAI,total,PDCCH}) may have a value that is greater than or equal to the value of the assignment index 906-a (e.g., a total DAI for PDSCH tracking, V_{DAI,total,PDSCH}) because the assignment index 906-b tracks both scheduling downlink control channels (e.g., downlink control channels that schedule downlink shared channels) and non-scheduling downlink control channels (e.g., uplink scheduling downlink control channels, group-common downlink control channels). Having separate feedback bits for downlink control channels and downlink shared channels using two assignment index fields, where one tracks downlink control channels and one tracks downlink shared channels, enables the NE and/or the UE to distinguish between downlink control channel misdetection and a NACK for the downlink shared channel, and may save feedback overhead. For example, if the UE receives a downlink control channel that includes both the assignment index 906-a and the assignment index 906-b, and the values of the two assignment indexes differ for a given downlink control channel monitoring occasion, then the UE may determine that one or more non-scheduling downlink control channels were transmitted in that monitoring occasion. The UE may use the assignment index 906-a to determine a first numerical quantity of bits associated with a first field of the feedback (e.g., for downlink shared channel reception) and the assignment index 906-b to determine a second numerical quantity of bits associated with a second field of the feedback (e.g., for downlink control channel reception).

In some examples, a first (counter-DAI, Total-DAI) pair, and a second (counter-DAI, Total-DAI) pair are defined for a DCI format. The first pair tracks the scheduled PDSCHs and the second pair tracks the transmitted PDCCHs (e.g., of one or more DCI formats). The second pair may track additional transmitted PDCCHs that are not scheduling PDSCHs. In some other examples, a first counter-DAI and Total-DAI pair tracks the scheduled PDSCHs, and a second counter-DAI or a second Total-DAI tracks the transmitted PDCCHs. In some other examples, a first counter-DAI tracks the scheduled PDSCHs, and a second counter-DAI tracks the transmitted PDCCHs.

As used herein, a DAI or assignment index field may be described as tracking downlink control channels, downlink shared channels, or other transmissions. In this context, tracking refers to the DAI or assignment index field maintaining a count or indication of the numerical quantity (e.g., number, amount) of the respective transmissions that have been scheduled or transmitted within a time period or monitoring occasion. For example, a DAI that tracks downlink shared channels may increment or otherwise indicate a cumulative count of downlink shared channels scheduled by downlink control channels, enabling a receiving device to detect whether any scheduled transmissions were missed based on discontinuities or gaps in the tracked values across consecutive monitoring occasions.

FIG. 10 illustrates an example of a transmission diagram 1000 in accordance with aspects of the present disclosure. In some examples, the transmission diagram 1000 implements or is implemented by aspects of the wireless communications system 100, the resource diagram 200, the transmission diagram 500, the transmission diagram 600, the transmission diagram 700, the transmission diagram 800, and/or the transmission diagram 900. For example, the transmission diagram 1000 may be implemented by one or more UEs and/or NEs, which may be an example of NEs 102 and UEs 104, as described with reference to FIG. 1. The transmission diagram 1000 illustrates an example of a single assignment index for tracking feedback associated with both downlink shared channels and downlink control channels.

In some cases, the transmission diagram 1000 includes one or more PDSCHs 1002 that are scheduled by one or more PDCCHs 1004, along with a corresponding assignment index 1006 and feedback. In some cases, there may be six PDSCHs 1002, where feedback for the PDSCHs 1002 includes an ACK 1008-a, a NACK 1010-a, an empty entry, a NACK 1010-b, a NACK 1010-c, and a NACK 1010-d, respectively. There may also be six PDCCHs 1004, where feedback for the PDCCHs 1004 includes an ACK 1008-b, an ACK 1008-c, an ACK 1008-d, a NACK 1010-e, a NACK 1010-f, and an ACK 1008-e, respectively. An assignment index 1006 tracking the PDSCHs 1002 and the PDCCHs 1004 may have values 1, 2, 3, 4, 5, and 6. The transmission diagram 1000 uses a single assignment index 1006 for both the PDSCH 1002 and the PDCCH 1004, providing an alternative approach to tracking feedback compared to the transmission diagram 900.

In some examples, using a single assignment index 1006 may save bits in the DCI compared to using two separate assignment index fields, but may result in more feedback overhead. For example, if the UE does not detect a downlink control channel, then the UE may not know whether the missed downlink control channel was a scheduling downlink control channel or a non-scheduling downlink control channel. The UE may infer that no HARQ-ACK bit is used for an assignment index value if the UE has decoded the downlink control channel and determined that the downlink control channel is not a downlink scheduling downlink control channel. In the transmission diagram 1000, the empty entry for the PDSCHs 1002 corresponding to the assignment index value of 3 indicates that the downlink control channel with assignment index value 3 is a non-scheduling downlink control channel (e.g., an uplink scheduling downlink control channel or a group-common downlink control channel), and therefore no PDSCH feedback bit is associated with that assignment index value.

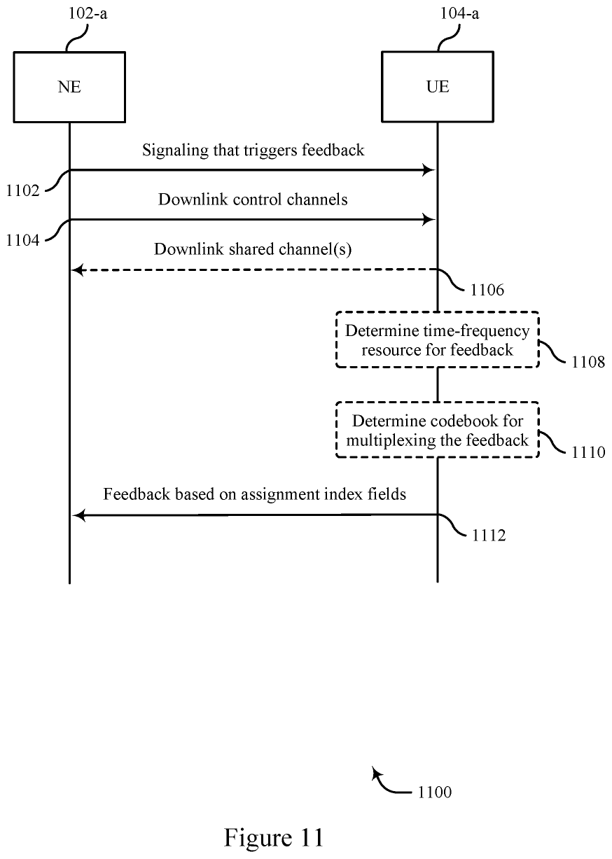

FIG. 11 illustrates an example of a signaling diagram 1100 in accordance with aspects of the present disclosure. In some examples, the signaling diagram 1100 implements or is implemented by aspects of the wireless communications system 100, the resource diagram 200, the transmission diagram 500, the transmission diagram 600, the transmission diagram 700, the transmission diagram 800, the transmission diagram 900, and/or the transmission diagram 1000. The signaling diagram 1100 may implement or be implemented by NE 102-a and UE 104-a, which may be examples of the corresponding devices as described with reference to FIG. 1. For example, the NE 102-a may provide the UE 104-a with signaling that triggers feedback associated with a set of downlink control channels, where the UE 104-a transmits the feedback based on one or more assignment index fields. Alternative examples of the following may be implemented, where some processes are performed in a different order than described or are not performed. In some cases, processes may include additional features not mentioned below, or further processes may be added.

At 1102, the NE 102-a transmits signaling that triggers feedback to the UE 104-a. The signaling may include at least one of an additional downlink control channel or a WUS. In some examples, the additional downlink control channel does not schedule an additional downlink shared channel. The additional downlink control channel includes respective fields for a set of groups of UEs, where each field triggers the feedback for UEs in a respective group. The signaling may trigger the feedback if at least one format matches a set of downlink control channels. Additionally, or alternatively, the signaling may trigger the feedback if the set of downlink control channels includes a change in a BWP identifier. Additionally, or alternatively, the signaling may trigger the feedback if the set of downlink control channels falls outside of a reduced processing state of the UE 104-a. In some examples, the signaling indicates a set of resources in at least one of a time domain or a frequency domain. The signaling may indicate the set of resources using a search space set identifier or a CORESET identifier. For example, the signaling may indicate a time duration by indicating a search space set identifier in a DCI message, and may indicate a frequency span by indicating a CORESET identifier in the DCI message. The set of resources may follow a search space set periodicity for the set of downlink control channels. In some cases, the signaling triggers the feedback corresponding to downlink control channels associated with a search space set identifier or a CORESET identifier.

In some examples, the signaling indicates an uplink control channel configuration selected from a set of uplink control channel configurations for the feedback. The set of uplink control channel configurations indicates respective numerical quantities of repetitions, respective coding rates, and respective reliability values for a payload size. In some examples, at least one uplink control channel configuration of the set of uplink control channel configurations includes parameters resulting in a first reliability for a payload size, and at least one uplink control channel configuration of the set of uplink control channel configurations includes parameters resulting in a second reliability for the payload size, where the first reliability is higher than the second reliability. Each uplink control channel configuration may include a maximum number of repetitions and a coding rate. The uplink control channel configuration is applicable to an uplink control channel resource to carry the feedback. In some examples, the NE 102-a transmits a PDCCH0 prior to a first PDCCH, a second PDCCH, and a third PDCCH, where PDCCH0 enables PDCCHs sent in a time duration and/or in a frequency span to have a second assignment index field in corresponding DCI messages. PDCCH0 may include a DCI message that indicates the time duration and/or the frequency span (e.g., the signaling at 1102 may be the PDCCH0).

At 1104, the NE 102-a transmits downlink control channels to the UE 104-a. The set of downlink control channels includes a first assignment index field that tracks scheduled downlink shared channels and a second assignment index field that tracks downlink control channel transmissions. The first assignment index field counts a total numerical quantity of scheduled downlink shared channels up to a current downlink control channel monitoring occasion. The second assignment index field counts a total numerical quantity of downlink control channel transmissions up to the current downlink control channel monitoring occasion. In some examples, a value of the second assignment index field is greater than or equal to a value of the first assignment index field. The set of downlink control channels may include a first set of downlink control channels that schedule the set of downlink shared channels with HARQ-ACK reporting enabled and a second set of downlink control channels that do not enable HARQ-ACK reporting in response to a downlink shared channel. In some examples, the first assignment index field indicates a first numerical quantity of downlink control channels that schedule the set of downlink shared channels. The second assignment index field indicates a second numerical quantity of downlink control channels that do not schedule the set of downlink shared channels. The set of downlink control channels may include a field that instructs the UE 104-a to transmit the feedback. In some examples, the NE 102-a transmits a downlink control channel of the set of downlink control channels with a set of repetitions. The NE 102-a transmits the set of downlink control channels using a set of resources in at least one of a time domain or a frequency domain.

For example, the NE 102-a transmits a first PDCCH including a first DCI message in a first PDCCH monitoring occasion, where the first DCI message includes a first assignment index field, AI1, set to a first value, V1, and a second assignment index field, AI2, set to a second value, V2, and where the first DCI message has enabled HARQ-ACK reporting for a scheduled PDSCH and schedules a PDSCH reception. The NE 102-a transmits a second PDCCH including a second DCI message in a second PDCCH monitoring occasion, where the second DCI message includes the first assignment index field, AI1, set to V1, and the second assignment index field, AI2, set to V2+1, and where the second DCI message does not schedule a PDSCH. The NE 102-a transmits a third PDCCH including a third DCI message in a third PDCCH monitoring occasion, where the third DCI message includes the first assignment index field, AI1, set to V1+1, and the second assignment index field, AI2, set to V2+2, and where the third DCI message has enabled HARQ-ACK reporting for a scheduled PDSCH and schedules a PDSCH reception. In some examples, for each DCI of the first set of PDCCHs, the DCI includes a first total assignment index (TAI), which indicates a total number of DCIs sent in a first set of PDCCH monitoring occasions up to the current PDCCH monitoring occasion. For each DCI of the second set of PDCCHs, the DCI includes a second total assignment index (TAI), which indicates a total number of DCIs sent in a second set of PDCCH monitoring occasions up to the current PDCCH monitoring occasion. In some cases, the first TAI and the second TAI are different for a PDCCH monitoring occasion. In some examples, the DCIs of the first set of PDCCHs are downlink scheduling DCIs, and the DCIs of the second set of PDCCHs are non-scheduling DCIs and uplink scheduling DCIs.

In some examples, at 1106, the NE 102-a may transmit downlink shared channels to the UE 104-a. The NE 102-a may transmit a downlink shared channel of the set of downlink shared channels if a downlink control channel of the set of downlink control channels schedules the downlink shared channel. The UE 104-a receives the downlink shared channel if the downlink control channel schedules the downlink shared channel. In some examples, the NE 102-a transmits additional signaling prior to the signaling at 1102, where the additional signaling indicates a first codebook size (e.g., or a first maximum and/or minimum codebook size) for first feedback and a second codebook size (e.g., or a second maximum and/or minimum codebook size) for second feedback. The first feedback includes the first field and the second field if at least one first downlink control channel of the set of downlink control channels schedules at least one downlink shared channel of the set of downlink shared channels. The second feedback includes the first field if at least one second downlink control channel of the set of downlink control channels does not schedule any downlink shared channel. The feedback includes at least one of the first feedback or the second feedback. For example, the NE 102-a configures the UE 104-a with at least two maximum HARQ-ACK codebook sizes. For PDCCHs for which the UE 104-a is to provide feedback for DCI detection, a first maximum HARQ-ACK codebook size is used. For PDCCHs for which the UE 104-a is not to provide feedback for DCI detection, a second maximum HARQ-ACK codebook size is used, where the first and the second maximum HARQ-ACK codebook sizes are different.

In some cases, at 1108, the UE 104-a determines a time-frequency resource for feedback. The UE 104-a may determine the time-frequency resource using a first time domain offset from a last symbol of the signaling or a first slot of the signaling at 1102. The signaling may indicate the first time domain offset. Additionally, or alternatively, the UE 104-a may determine the time-frequency resource using a second time domain offset from a last symbol of respective downlink control channels of the set of downlink control channels or a second slot of the respective downlink control channels. In some examples, the UE 104-a receives additional signaling prior to the signaling at 1102, which indicates the time-frequency resource. The UE 104-a may determine the time-frequency resource using a periodicity of a reference search space, where the reference search space defines monitoring occasions for the set of downlink control channels. In some examples, the feedback is provided in a PUCCH resource determined based on a reference search space periodicity and an offset with respect to the search space set. In some cases, at least one of the signaling or the set of downlink control channels includes a field that indicates the time-frequency resource. The UE 104-a may determine the time-frequency resource using a rule. The rule may indicate that the time-frequency resource is a first available uplink slot after a slot including the signaling, where the first available uplink slot occurs at least one or more slots after the slot including the signaling. The NE 102-a may also determine the time-frequency resource for the feedback, and the UE 104-a transmits the feedback using the time-frequency resource.

In some cases, at 1110, the UE 104-a determines a codebook for multiplexing the feedback. The UE 104-a determines a first numerical quantity of bits for a first field using the first assignment index field. The UE 104-a determines a second numerical quantity of bits for a second field using the second assignment index field. The first assignment index field and the second assignment index field include different values for a downlink control channel monitoring occasion. The UE 104-a determines a codebook for the downlink control channel. The codebook includes the first field and the second field if the downlink control channel schedules the downlink shared channel. In some examples, the UE 104-a orders one or more bits in the codebook according to downlink control channel monitoring occasions. A first bit of the second field follows one or more first bits of the first field for one or more first downlink control channels in a first downlink control channel monitoring occasion. A second bit of the second field follows one or more second bits of the first field for one or more second downlink control channels in a second downlink control channel monitoring occasion. The first downlink control channel monitoring occasion occurs prior to the second downlink control channel monitoring occasion. In some examples, the UE 104-a determines a codebook for a downlink control channel of the set of downlink control channels. The codebook includes the second field if the downlink control channel does not schedule any downlink shared channel. The UE 104-a multiplexes the feedback in the codebook. The NE 102-a may also determine the first numerical quantity of bits for the first field using the first assignment index field and the second numerical quantity of bits for the second field using the second assignment index field.

At 1112, the UE 104-a transmits feedback using the assignment index fields to the NE 102-a. The feedback includes a first field that indicates reception of the set of downlink shared channels and a second field that indicates reception of the set of downlink control channels. The first field includes a first set of bits that indicates whether the UE 104-a has successfully decoded a downlink shared channel scheduled by a downlink control channel of the set of downlink control channels. The second field includes a second set of bits that indicates whether the UE 104-a has successfully decoded the downlink control channel. In some examples, the HARQ-ACK feedback includes one bit for each downlink scheduling DCI indicating whether the UE 104-a has received and detected the DCI successfully, and one bit indicating whether the UE 104-a has received and detected the PDSCH scheduled by the DCI successfully. For each DCI that does not schedule a PDSCH, the HARQ-ACK feedback includes one bit indicating whether the UE 104-a has received and detected the DCI successfully. In some examples, at least one of the first field or the second field includes a single value for the downlink control channel if the NE 102-a transmits the downlink control channel with a set of repetitions. The NE 102-a receives the feedback using the first assignment index field and the second assignment index field. For example, the NE 102-a receives HARQ-ACK feedback associated with the first, second, and third PDCCHs, and interprets the feedback using at least the first assignment index field, AI1, and the second assignment index field, AI2. In some examples, the NE 102-a receives a first HARQ-ACK feedback associated with the first set of PDCCHs and a second feedback associated with the second set of PDCCHs, and interprets the first HARQ-ACK feedback using at least the first TAI field and the second feedback using at least the second TAI field. The feedback includes the first field that indicates reception of the set of downlink shared channels at the UE 104-a and the second field that indicates reception of the set of downlink control channels at the UE 104-a. The UE 104-a multiplexes the feedback in a codebook for the downlink control channel. The codebook includes the first field and the second field if the downlink control channel schedules the downlink shared channel. In some examples, the UE 104-a multiplexes the feedback in a codebook for a downlink control channel. The codebook includes the second field if the downlink control channel does not schedule any downlink shared channel. The UE 104-a monitors for the set of downlink control channels using a set of resources in at least one of a time domain or a frequency domain.

In some examples, the set of downlink control channels may include a single assignment index field that tracks both scheduled downlink shared channels and downlink control channel transmissions, rather than separate first and second assignment index fields. The single assignment index field may be incremented for each downlink control channel transmission, regardless of whether the downlink control channel schedules a downlink shared channel or is a non-scheduling downlink control channel. For example, the NE 102-a may transmit a first PDCCH with the single assignment index field set to a value of 1, where the first PDCCH schedules a PDSCH. The NE 102-a may transmit a second PDCCH with the single assignment index field set to a value of 2, where the second PDCCH is a non-scheduling DCI (e.g., a group-common DCI or an uplink scheduling DCI). The NE 102-a may transmit a third PDCCH with the single assignment index field set to a value of 3, where the third PDCCH schedules another PDSCH. The UE 104-a may infer that no HARQ-ACK bit is used for an assignment index value if the UE 104-a has decoded the downlink control channel and determined that the downlink control channel is not a downlink scheduling downlink control channel. In such cases, the feedback codebook may include an empty entry or a placeholder for the assignment index value corresponding to the non-scheduling downlink control channel, as described with reference to FIG. 10. The UE 104-a may construct the feedback codebook based on the highest value of the single assignment index field received, and the NE 102-a may interpret the feedback using the single assignment index field to correlate each feedback bit with a corresponding downlink control channel transmission.

In some examples, the codebook or the feedback may include an indication of whether the feedback includes downlink control channel feedback, downlink shared channel feedback, or both. In some other examples, the feedback may include an indication of whether the feedback includes downlink control channel feedback in addition to downlink shared channel feedback. The indication may be provided via a bit-field in the feedback. Additionally, or alternatively, the indication may be determined based on a time and/or frequency location of the feedback, such as the time-frequency resource on which the feedback is transmitted.

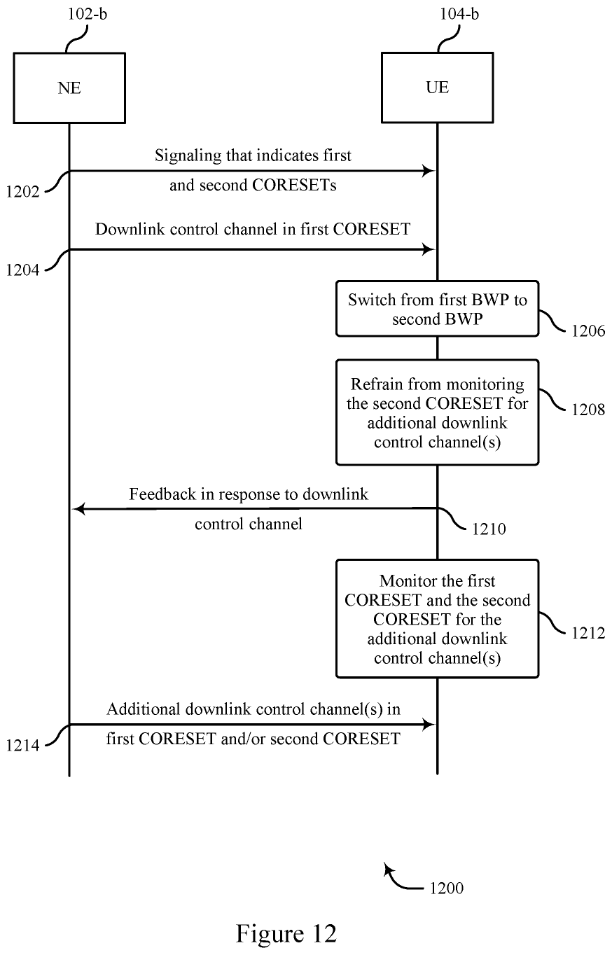

FIG. 12 illustrates an example of a signaling diagram 1200 in accordance with aspects of the present disclosure. In some examples, the signaling diagram 1200 implements or is implemented by aspects of the wireless communications system 100, the resource diagram 200, the transmission diagram 300, and/or the transmission diagram 400. The signaling diagram 1200 may implement or be implemented by NE 102-b and UE 104-b, which may be examples of the corresponding devices as described with reference to FIG. 1. For example, the NE 102-b may provide the UE 104-b with signaling that indicates a common CORESET shared between BWPs, and the UE 104-b may use the common CORESET during a BWP switch. Alternative examples of the following may be implemented, where some processes are performed in a different order than described or are not performed. In some cases, processes may include additional features not mentioned below, or further processes may be added.

At 1202, the NE 102-b transmits signaling that indicates a first CORESET and a second CORESET to the UE 104-b. The first CORESET spans both a first BWP and a second BWP, and the second CORESET spans the second BWP. In some examples, the signaling indicates a first numerical quantity of time resources that the first CORESET occupies in the first BWP and a second numerical quantity of time resources that the first CORESET occupies in the second BWP. For example, the first CORESET may have a duration of six symbols in the first BWP and a duration of three symbols in the second BWP. The signaling may include RRC signaling that configures the UE 104-b with the first CORESET and the second CORESET for the respective BWPs. In some examples, the first CORESET includes a set of one or more CORESETs that the NE 102-b configures for the first BWP. The UE 104-b selects the first CORESET from a set of CORESETs that the NE 102-b configures for the first BWP when one or more conditions are met, including the first CORESET having a size that exceeds other CORESETs in the set, the NE 102-b configures the first CORESET for BWP switching, or the first CORESET includes more overlapping RBs between the first BWP and the second BWP than other CORESETs. In some examples, the first BWP and the second BWP share one or more overlapping RBs and have a same center frequency, and the UE 104-b refrains from performing radio frequency retuning because the BWPs share the overlapping RBs and the same center frequency.

At 1204, the NE 102-b transmits a first downlink control channel in the first CORESET to the UE 104-b. The first downlink control channel indicates to switch from the first BWP to the second BWP. In some examples, the first downlink control channel schedules a downlink shared channel, and the NE 102-b transmits the downlink shared channel to the UE 104-b. The UE 104-b receives the downlink shared channel, and the feedback includes an acknowledgment that the UE 104-b generates after decoding the downlink shared channel. In some other examples, the first downlink control channel operates independently of a downlink shared channel (e.g., a non-scheduling DCI or a group-common DCI), and the feedback includes an acknowledgment that the UE 104-b generates after decoding the first downlink control channel. The NE 102-b refrains from transmitting a second downlink control channel in the second CORESET until the NE 102-b receives feedback that responds to the first downlink control channel.

At 1206, the UE 104-b switches from the first BWP to the second BWP after receiving the first downlink control channel. The UE 104-b performs the BWP switch if the UE 104-b receives the first downlink control channel that indicates the BWP switch. In some examples, the UE 104-b monitors at least a subset of the first CORESET for a second downlink control channel after switching from the first BWP to the second BWP and before transmitting the feedback. The UE 104-b monitors the first CORESET for the second downlink control channel if the second BWP exceeds the first BWP in size.

At 1208, the UE 104-b refrains from monitoring the second CORESET for additional downlink control channels until the UE 104-b transmits feedback that responds to the first downlink control channel. The UE 104-b monitors the first CORESET for the second downlink control channel while refraining from monitoring the second CORESET. In some examples, the UE 104-b monitors the first CORESET for the second downlink control channel after switching from the first BWP to the second BWP and before transmitting the feedback, where the UE 104-b uses a search space set that the NE 102-b configures for the first CORESET in the first BWP. In some examples, the UE 104-b monitors the first CORESET for the second downlink control channel after switching from the first BWP to the second BWP and before transmitting the feedback, where the UE 104-b uses the first numerical quantity of time resources that the first CORESET occupies in the first BWP. In some other examples, the UE 104-b monitors the first CORESET for the second downlink control channel after switching from the first BWP to the second BWP and before transmitting the feedback, where the UE 104-b uses the second numerical quantity of time resources that the first CORESET occupies in the second BWP. In some examples, the UE 104-b starts a timer after receiving the first downlink control channel, where the timer controls how long the UE 104-b monitors the first CORESET for the second downlink control channel, and the UE 104-b refrains from monitoring the first CORESET for the second downlink control channel if the timer expires.

In some cases, the first downlink control channel schedules a downlink shared channel, and the UE 104-b receives the downlink shared channel. The downlink shared channel may be a downlink broadcast channel (e.g., a downlink broadcast channel carrying system information block (SIB) 1 (SIB1) information) for which the UE 104-b does not provide feedback. In some examples, the initial timer value can be set to a value according to SIB1 periodicity and repetition.

At 1210, the UE 104-b transmits feedback in response to the first downlink control channel to the NE 102-b. The feedback may include an acknowledgment that the UE 104-b generates after decoding a downlink shared channel that the first downlink control channel schedules, or an acknowledgment that the UE 104-b generates after decoding the first downlink control channel if the first downlink control channel operates independently of a downlink shared channel. The NE 102-b receives the feedback in response to the first downlink control channel.

At 1212, the UE 104-b monitors the first CORESET and the second CORESET for additional downlink control channels after the UE 104-b transmits the feedback and switches from the first BWP to the second BWP. After transmitting the feedback, the UE 104-b begins monitoring both the first CORESET and the second CORESET for downlink control channels in the second BWP. In some examples, the UE 104-b monitors the first CORESET for the second downlink control channel after transmitting the feedback, where the UE 104-b uses the second numerical quantity of time resources that the first CORESET occupies in the second BWP. For example, if the first CORESET has a duration of six symbols in the first BWP and a duration of three symbols in the second BWP, then the UE 104-b monitors the first CORESET with the three symbol duration after transmitting the feedback.

At 1214, the NE 102-b transmits additional downlink control channels in the first CORESET and/or the second CORESET to the UE 104-b. The NE 102-b transmits the second downlink control channel in at least one of the first CORESET or the second CORESET after the NE 102-b receives the feedback. In some examples, the NE 102-b transmits the second downlink control channel in at least a subset of the first CORESET after transmitting the first downlink control channel and before receiving the feedback. The NE 102-b may transmit the second downlink control channel during the first CORESET after transmitting the first downlink control channel and before receiving the feedback, where the NE 102-b uses the first numerical quantity of time resources, the second numerical quantity of time resources, or a search space set that the NE 102-b configures for the first CORESET in the first BWP. The NE 102-b may transmit the second downlink control channel during the first CORESET after transmitting the first downlink control channel and before receiving the feedback when the second BWP exceeds the first BWP in size.

In some examples, the UE 104-b receives the second downlink control channel by monitoring the first CORESET and the second CORESET, where the second downlink control channel schedules a downlink shared channel. The UE 104-b receives the downlink shared channel and transmits additional feedback after decoding the downlink shared channel. The UE 104-b monitors the first CORESET and the second CORESET for one or more third downlink control channels after the UE 104-b transmits the additional feedback. The NE 102-b transmits the second downlink control channel, where the second downlink control channel schedules a downlink shared channel. The NE 102-b transmits the downlink shared channel, receives additional feedback after the UE 104-b decodes the downlink shared channel, and transmits one or more third downlink control channels in the first CORESET and the second CORESET after the NE 102-b receives the additional feedback.

In some examples, the first BWP and the second BWP share one or more overlapping RBs. The UE 104-b determines at least one RB index for the downlink shared channel by using a set of RB indices that define the first BWP, where the UE 104-b receives the downlink shared channel in the one or more overlapping RBs at the determined RB index. The NE 102-b determines at least one RB index for the downlink shared channel by using a set of RB indices that define the first BWP, where the NE 102-b transmits the downlink shared channel in the one or more overlapping RBs at the determined RB index. The NE 102-b selects the first CORESET from a set of CORESETs that the NE 102-b configures for the first BWP if one or more conditions are met, including the first CORESET having a size that exceeds other CORESETs in the set, the NE 102-b configures the first CORESET for BWP switching, or the first CORESET includes more overlapping RBs between the first BWP and the second BWP than other CORESETs.

In some cases, an RB indexing for the largest configured BWP in a cell is also applicable to at least a set of smaller configured BWPs for the cell. Additionally, or alternatively, RBs present in both the first BWP and the second BWP have the same RB index across the first and second BWPs. In some examples, a first CORESET is configured for a first BWP, and the UE 104-b determines a second CORESET for the second BWP based on the first CORESET of the first BWP, and/or RBs or BW of the first and the second BWP. In some cases, after receiving the command to transition from the first BWP to the second BWP, the UE 104-b starts monitoring the second CORESET at least until transmitting an acknowledgement (e.g., an ACK) in response to a DCI or until a timer expires. In some cases, the second CORESET is a subset of the first CORESET.

The techniques described herein may be implemented together or separately to improve reliability and efficiency of wireless communications during BWP switching operations. For example, a common CORESET configuration addresses misalignment between NEs and UEs by providing a shared control resource set that spans multiple BWPs, enabling the NEs to transmit downlink control channels that the UEs can receive regardless of whether the NEs have confirmed the BWP switch. The feedback mechanisms may implement the common CORESET configuration and/or may provide differentiated feedback that distinguishes between downlink control channel reception and downlink shared channel reception, enabling NEs to identify whether UEs successfully received and decoded a BWP switch indication.

In some examples, the common CORESET configuration and the feedback mechanisms may be combined to provide enhanced reliability during BWP switching. For example, an NE (e.g., the NE 102-b) may transmit a downlink control channel in a common CORESET that indicates a BWP switch, and a UE (e.g., the UE 104-b) may provide feedback using assignment index fields, as described with reference to FIGS. 9 through 11, to indicate successful reception of the downlink control channel. The feedback may include a first field associated with reception of downlink shared channels and a second field associated with reception of downlink control channels, enabling the NE to distinguish between a missed BWP switch indication and a failed downlink shared channel decoding. By combining the common CORESET configuration with the differentiated feedback mechanisms, the NE and the UE may maintain alignment regarding the active BWP and reduce communication failures caused by misdetection of BWP switch indications.

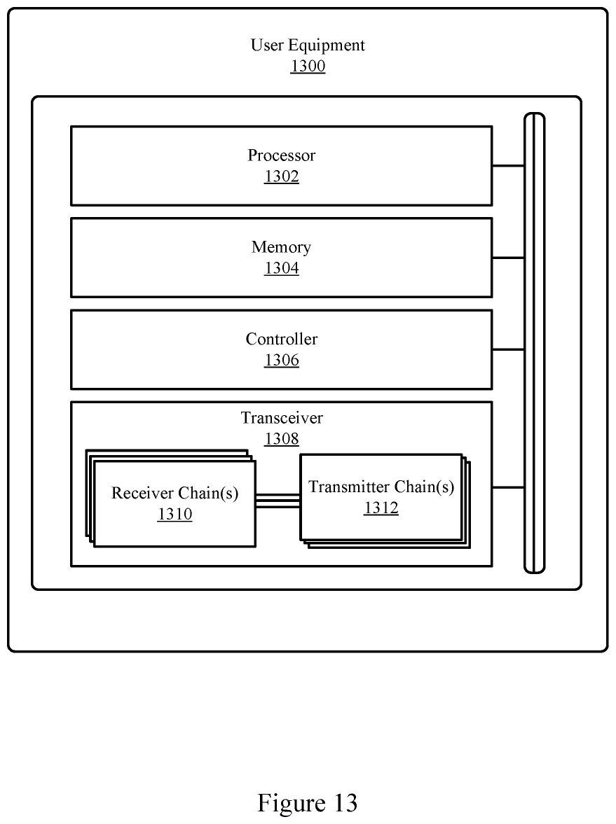

FIG. 13 illustrates an example of a UE 1300 in accordance with aspects of the present disclosure. The UE 1300 may include a processor 1302, a memory 1304, a controller 1306, and a transceiver 1308. The processor 1302, the memory 1304, the controller 1306, or the transceiver 1308, or various combinations thereof or various components thereof may be examples of means for performing various aspects of the present disclosure as described herein. These components may be coupled (e.g., operatively, communicatively, functionally, electronically, electrically) via one or more interfaces.

The processor 1302, the memory 1304, the controller 1306, or the transceiver 1308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1302 may include an intelligent hardware device (e.g., a general-purpose processor, a DSP, a central processing unit (CPU), an ASIC, a field-programmable gate-array (FPGA), or any combination thereof). In some implementations, the processor 1302 may be configured to operate the memory 1304. In some other implementations, the memory 1304 may be integrated into the processor 1302. The processor 1302 may be configured to execute computer-readable instructions stored in the memory 1304 to cause the UE 1300 to perform various functions of the present disclosure.

The memory 1304 may include volatile or non-volatile memory. The memory 1304 may store computer-readable, computer-executable code including instructions that, when executed by the processor 1302, cause the UE 1300 to perform various functions described herein. The code may be stored in a non-transitory computer-readable medium such as the memory 1304 or another type of memory. Computer-readable media include both non-transitory computer storage media and communication media, including any medium that facilitates transfer of a computer program from one place to another. A non-transitory storage medium may be any available medium that may be accessed by a general-purpose or special-purpose computer.

In some implementations, the processor 1302 and the memory 1304 coupled with the processor 1302 may be configured to cause the UE 1300 to perform one or more of the functions described herein (e.g., executing, by the processor 1302, instructions stored in the memory 1304). For example, the processor 1302 may support wireless communication at the UE 1300 in accordance with examples as disclosed herein. The UE 1300 may be configured to or operable to support a means for receiving signaling that indicates a first CORESET and a second CORESET, where the first CORESET is associated with a first BWP and a second BWP, and where the second CORESET is associated with the second BWP, receiving, in the first CORESET, a first downlink control channel that indicates to switch from the first BWP to the second BWP, switching, based on the first downlink control channel, from the first BWP to the second BWP, refraining, prior to transmission of feedback in response to the first downlink control channel, from monitoring the second CORESET for a second downlink control channel, transmitting the feedback in response to the first downlink control channel, and monitoring, based on the feedback and switching from the first BWP to the second BWP, the first CORESET and the second CORESET for the second downlink control channel. By refraining from monitoring the second CORESET prior to transmission of feedback and then monitoring both CORESETs after feedback transmission, the UE 1300 may reduce power consumption during the transition period, while ensuring reliable control channel reception after the BWP switch is confirmed, thereby improving alignment between the UE 1300 and the NE regarding the active BWP.

Additionally, the UE 1300 may be configured to or operable to support any one or combination of monitoring, prior to the transmission of the feedback and after switching from the first BWP to the second BWP, at least a subset of the first CORESET for the second downlink control channel. Monitoring at least a subset of the first CORESET during this transition period enables the UE 1300 to maintain control channel reception continuity, while minimizing monitoring overhead. Additionally, or alternatively, the UE 1300 may be configured to or operable to support receiving the second downlink control channel based on monitoring the first CORESET and the second CORESET, where the second downlink control channel schedules a downlink shared channel, receiving the downlink shared channel, transmitting additional feedback in response to decoding the downlink shared channel, and monitoring the first CORESET and the second CORESET for one or more third downlink control channels based on the additional feedback. This approach enables efficient scheduling and reception of downlink data, while maintaining reliable feedback mechanisms that allow the NE to track successful data delivery. Additionally, or alternatively, the first BWP and the second BWP include one or more overlapping RBs, and the UE 1300 may be configured to or operable to support determining at least one RB index associated with the downlink shared channel based on a set of RB indices associated with the first BWP, where the downlink shared channel is received in the one or more overlapping RBs based on the at least one RB index. Utilizing overlapping RBs and determining RB indices based on the first BWP enables seamless data reception during the BWP transition without requiring additional resource allocation signaling.

Additionally, or alternatively, the UE 1300 may be configured to or operable to support starting, after receiving the first downlink control channel, a timer associated with monitoring the first CORESET for the second downlink control channel, and refraining from monitoring the first CORESET for the second downlink control channel based on expiry of the timer. The timer-based approach provides a deterministic mechanism for transitioning monitoring behavior, reducing UE power consumption by limiting the duration of extended CORESET monitoring. Additionally, or alternatively, the first downlink control channel schedules a downlink shared channel, and the UE 1300 may be configured to or operable to support receiving the downlink shared channel, where the feedback includes an acknowledgment in response to decoding the downlink shared channel. Providing acknowledgment feedback in response to decoding the downlink shared channel enables the NE to confirm successful data delivery and BWP switch completion simultaneously. Additionally, or alternatively, the UE 1300 may be configured to or operable to support the first downlink control channel is independent of a downlink shared channel, and the feedback includes an acknowledgment in response to decoding the first downlink control channel. Providing acknowledgment feedback for control channel reception independent of data scheduling enables the NE to confirm BWP switch reception even when no data is scheduled, reducing misalignment between the UE 1300 and the NE.

Additionally, or alternatively, the signaling indicates a first numerical quantity of time resources associated with the first CORESET in the first BWP and a second numerical quantity of time resources associated with the first CORESET in the second BWP, and the UE 1300 may be configured to or operable to support monitoring, prior to the transmission of the feedback and after switching from the first BWP to the second BWP, the first CORESET for the second downlink control channel based on the first numerical quantity of time resources, and monitoring, after transmitting the feedback, the first CORESET for the second downlink control channel based on the second numerical quantity of time resources. This approach enables flexible CORESET configuration that adapts to different BWP characteristics, while maintaining monitoring continuity during the transition. Additionally, or alternatively, the signaling indicates a first numerical quantity of time resources associated with the first CORESET in the first BWP and a second numerical quantity of time resources associated with the first CORESET in the second BWP, and the UE 1300 may be configured to or operable to support monitoring, prior to the transmission of the feedback and after switching from the first BWP to the second BWP, the first CORESET for the second downlink control channel based on the second numerical quantity of time resources. Using the second numerical quantity of time resources during the transition period enables the UE 1300 to immediately adopt the target BWP configuration, simplifying the monitoring behavior and reducing implementation complexity.

Additionally, or alternatively, the UE 1300 may be configured to or operable to support refraining from performing radio frequency retuning based on the first BWP and the second BWP including one or more overlapping RBs and having a same center frequency. Avoiding radio frequency retuning when BWPs share overlapping RBs and the same center frequency reduces switching latency and power consumption during BWP transitions. Additionally, or alternatively, the UE 1300 may be configured to or operable to support monitoring, prior to the transmission of the feedback and after switching from the first BWP to the second BWP, the first CORESET for the second downlink control channel based on a search space set associated with the first CORESET in the first BWP. Using the search space set from the first BWP during the transition period maintains monitoring consistency and enables the UE 1300 to receive control channels without reconfiguration. Additionally, or alternatively, the UE 1300 may be configured to or operable to support the first CORESET includes a set of one or more CORESETs configured for the first BWP. Configuring the first CORESET as a set of CORESETs provides flexibility in control channel monitoring and enables efficient resource utilization across multiple CORESETs. Additionally, or alternatively, the UE 1300 may be configured to or operable to support selecting the first CORESET from a set of CORESETs configured for the first BWP based on one or more of a size of the first CORESET having a greatest value of the set of CORESETs, the first CORESET being configured for BWP switching, or the first CORESET having a greatest numerical quantity of overlapping RBs between the first BWP and the second BWP. The selection criteria enable CORESET selection that maximizes control channel reception reliability during BWP switching, while minimizing resource overhead. Additionally, or alternatively, the UE 1300 may be configured to or operable to support monitoring, prior to the transmission of the feedback and after switching from the first BWP to the second BWP, the first CORESET for the second downlink control channel based on the second BWP being greater than the first BWP. Conditioning the monitoring behavior on the relative sizes of the BWPs enables adaptive behavior that accounts for the expanded frequency resources available in the larger target BWP.

Additionally, or alternatively, the UE 1300 may support at least one memory (e.g., the memory 1304) and at least one processor (e.g., the processor 1302) coupled with the at least one memory and configured to cause the UE to receive signaling that indicates a first CORESET and a second CORESET, where the first CORESET is associated with a first BWP and a second BWP, and where the second CORESET is associated with the second BWP, receive, in the first CORESET, a first downlink control channel that indicates to switch from the first BWP to the second BWP, switch, based on the first downlink control channel, from the first BWP to the second BWP, refrain, prior to transmission of feedback in response to the first downlink control channel, from monitoring the second CORESET for a second downlink control channel, transmit the feedback in response to the first downlink control channel, and monitor, based on the feedback and switching from the first BWP to the second BWP, the first CORESET and the second CORESET for the second downlink control channel.

Additionally, the UE 1300 may be configured to support any one or combination of to monitor, prior to the transmission of the feedback and after switching from the first BWP to the second BWP, at least a subset of the first CORESET for the second downlink control channel. Additionally, or alternatively, the UE 1300 may be configured to or operable to support to receive the second downlink control channel based on monitoring the first CORESET and the second CORESET, where the second downlink control channel schedules a downlink shared channel, receive the downlink shared channel, transmit additional feedback in response to decoding the downlink shared channel, and monitor the first CORESET and the second CORESET for one or more third downlink control channels based on the additional feedback. Additionally, or alternatively, the first BWP and the second BWP include one or more overlapping RBs, and the UE 1300 may be configured to or operable to support to determine at least one RB index associated with the downlink shared channel based on a set of RB indices associated with the first BWP, where the downlink shared channel is received in the one or more overlapping RBs based on the at least one RB index.

Additionally, or alternatively, the UE 1300 may be configured to or operable to support to start, after receiving the first downlink control channel, a timer associated with monitoring the first CORESET for the second downlink control channel, and refrain from monitoring the first CORESET for the second downlink control channel based on expiry of the timer. Additionally, or alternatively, the first downlink control channel schedules a downlink shared channel, and the UE 1300 may be configured to or operable to support to receive the downlink shared channel, where the feedback includes an acknowledgment in response to decoding the downlink shared channel. Additionally, or alternatively, the UE 1300 may be configured to or operable to support the first downlink control channel is independent of a downlink shared channel, and the feedback includes an acknowledgment in response to decoding the first downlink control channel.

Additionally, or alternatively, the signaling indicates a first numerical quantity of time resources associated with the first CORESET in the first BWP and a second numerical quantity of time resources associated with the first CORESET in the second BWP, and the UE 1300 may be configured to or operable to support to monitor, prior to the transmission of the feedback and after switching from the first BWP to the second BWP, the first CORESET for the second downlink control channel based on the first numerical quantity of time resources, and monitor, after transmitting the feedback, the first CORESET for the second downlink control channel based on the second numerical quantity of time resources. Additionally, or alternatively, the signaling indicates a first numerical quantity of time resources associated with the first CORESET in the first BWP and a second numerical quantity of time resources associated with the first CORESET in the second BWP, and the UE 1300 may be configured to or operable to support to monitor, prior to the transmission of the feedback and after switching from the first BWP to the second BWP, the first CORESET for the second downlink control channel based on the second numerical quantity of time resources.

Additionally, or alternatively, the UE 1300 may be configured to or operable to support to refrain from performing radio frequency retuning based on the first BWP and the second BWP including one or more overlapping RBs and having a same center frequency. Additionally, or alternatively, the UE 1300 may be configured to or operable to support to monitor, prior to the transmission of the feedback and after switching from the first BWP to the second BWP, the first CORESET for the second downlink control channel based on a search space set associated with the first CORESET in the first BWP. Additionally, or alternatively, the UE 1300 may be configured to or operable to support the first CORESET includes a set of one or more CORESETs configured for the first BWP. Additionally, or alternatively, the UE 1300 may be configured to or operable to support to select the first CORESET from a set of CORESETs configured for the first BWP based on one or more of a size of the first CORESET having a greatest value of the set of CORESETs, the first CORESET being configured for BWP switching, or the first CORESET having a greatest numerical quantity of overlapping RBs between the first BWP and the second BWP. Additionally, or alternatively, the UE 1300 may be configured to or operable to support to monitor, prior to the transmission of the feedback and after switching from the first BWP to the second BWP, the first CORESET for the second downlink control channel based on the second BWP being greater than the first BWP.

The controller 1306 may manage input and output signals for the UE 1300. The controller 1306 may also manage peripherals not integrated into the UE 1300. In some implementations, the controller 1306 may utilize an operating system such as iOS®, Android®, Windows®, or other operating systems. In some implementations, the controller 1306 may be implemented as part of the processor 1302.

In some implementations, the UE 1300 may include at least one transceiver 1308. In some other implementations, the UE 1300 may have more than one transceiver 1308. The transceiver 1308 may represent a wireless transceiver. The transceiver 1308 may include one or more receiver chains 1310, one or more transmitter chains 1312, or a combination thereof.

A receiver chain 1310 may be configured to receive signals (e.g., control information, data, packets) over a wireless medium. For example, the receiver chain 1310 may include one or more antennas to receive a signal over the air or a wireless medium. The receiver chain 1310 may include at least one amplifier (e.g., a low-noise amplifier (LNA)) configured to amplify the received signal. The receiver chain 1310 may include at least one demodulator configured to demodulate the received signal and obtain the transmitted data by reversing the modulation technique applied during transmission of the signal. The receiver chain 1310 may include at least one decoder for decoding the demodulated signal to receive the transmitted data.

A transmitter chain 1312 may be configured to generate and transmit signals (e.g., control information, data, packets). The transmitter chain 1312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 1312 may also include at least one power amplifier configured to amplify the modulated signal to an appropriate power level suitable for transmission over the wireless medium. The transmitter chain 1312 may also include one or more antennas for transmitting the amplified signal into the air or the wireless medium.

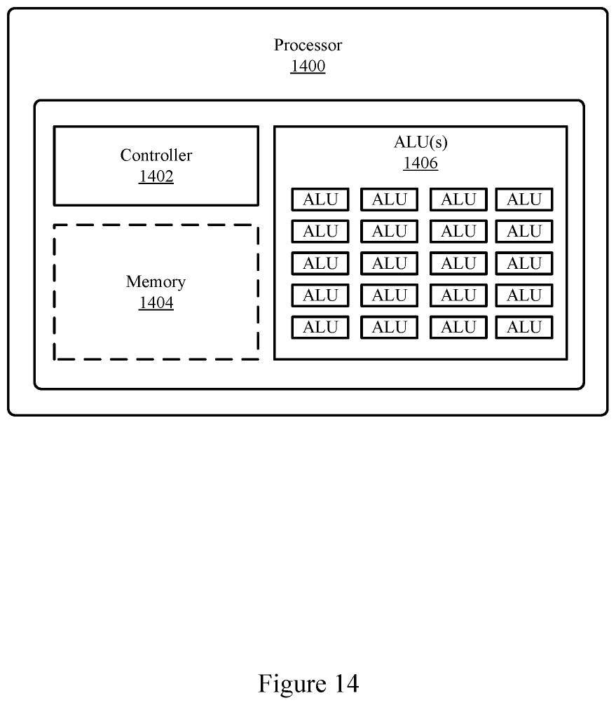

FIG. 14 illustrates an example of a processor 1400 in accordance with aspects of the present disclosure. The processor 1400 may be an example of a processor configured to perform various operations in accordance with examples as described herein. The processor 1400 may include a controller 1402 configured to perform various operations in accordance with examples as described herein. The processor 1400 may optionally include at least one memory 1404, which may be, for example, an L1/L2/L3 cache. Additionally, or alternatively, the processor 1400 may optionally include one or more arithmetic-logic units (ALUs) 1406. One or more of these components may be in electronic communication or otherwise coupled (e.g., operatively, communicatively, functionally, electronically, electrically) via one or more interfaces (e.g., buses).

The processor 1400 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1400) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1402 may be configured to manage and coordinate various operations (e.g., signaling, receiving, obtaining, retrieving, transmitting, outputting, forwarding, storing, determining, identifying, accessing, writing, reading) of the processor 1400 to cause the processor 1400 to support various operations in accordance with examples as described herein. For example, the controller 1402 may operate as a control unit of the processor 1400, generating control signals that manage the operation of various components of the processor 1400. These control signals include enabling or disabling functional units, selecting data paths, initiating memory access, and coordinating timing of operations.

The controller 1402 may be configured to fetch (e.g., obtain, retrieve, receive) instructions from the memory 1404 and determine subsequent instruction(s) to be executed to cause the processor 1400 to support various operations in accordance with examples as described herein. The controller 1402 may be configured to track memory addresses of instructions associated with the memory 1404. The controller 1402 may be configured to decode instructions to determine the operation to be performed and the operands involved. For example, the controller 1402 may be configured to interpret the instruction and determine control signals to be output to other components of the processor 1400 to cause the processor 1400 to support various operations in accordance with examples as described herein. Additionally, or alternatively, the controller 1402 may be configured to manage the flow of data within the processor 1400. The controller 1402 may be configured to control the transfer of data between registers, ALUs 1406, and other functional units of the processor 1400.

The memory 1404 may include one or more caches (e.g., memory local to or included in the processor 1400 or other memory, such as RAM, ROM, DRAM, SDRAM, SRAM, MRAM, flash memory, etc.). In some implementations, the memory 1404 may reside within or on a processor chipset (e.g., local to the processor 1400). In some other implementations, the memory 1404 may reside external to the processor chipset (e.g., remote to the processor 1400).

The memory 1404 may store computer-readable, computer-executable code including instructions that, when executed by the processor 1400, cause the processor 1400 to perform various functions described herein. The code may be stored in a non-transitory computer-readable medium such as system memory or another type of memory. The controller 1402 and/or the processor 1400 may be configured to execute computer-readable instructions stored in the memory 1404 to cause the processor 1400 to perform various functions. For example, the processor 1400 and/or the controller 1402 may be coupled with or to the memory 1404, the processor 1400, and the controller 1402, and may be configured to perform various functions described herein. In some examples, the processor 1400 may include multiple processors and the memory 1404 may include multiple memories. One or more of the multiple processors may be coupled with one or more of the multiple memories, which may, individually or collectively, be configured to perform various functions herein.

The one or more ALUs 1406 may be configured to support various operations in accordance with examples as described herein. In some implementations, the one or more ALUs 1406 may reside within or on a processor chipset (e.g., the processor 1400). In some other implementations, the one or more ALUs 1406 may reside external to the processor chipset (e.g., the processor 1400). One or more ALUs 1406 may perform one or more computations such as addition, subtraction, multiplication, and division on data. For example, one or more ALUs 1406 may receive input operands and an operation code, which determines an operation to be executed. One or more ALUs 1406 may be configured with a variety of logical and arithmetic circuits, including adders, subtractors, shifters, and logic gates, to process and manipulate the data according to the operation. Additionally, or alternatively, the one or more ALUs 1406 may support logical operations such as AND, OR, exclusive-OR (XOR), not-OR (NOR), and not-AND (NAND), enabling the one or more ALUs 1406 to handle conditional operations, comparisons, and bitwise operations.

The processor 1400 may support wireless communication in accordance with examples as disclosed herein. The processor 1400 may be configured to or operable to support at least one controller (e.g., the controller 1402) coupled with at least one memory (e.g., the memory 1404) and configured to cause the processor to receive signaling that indicates a first CORESET and a second CORESET, where the first CORESET is associated with a first BWP and a second BWP, and where the second CORESET is associated with the second BWP, receive, in the first CORESET, a first downlink control channel that indicates to switch from the first BWP to the second BWP, switch, based on the first downlink control channel, from the first BWP to the second BWP, refrain, prior to transmission of feedback in response to the first downlink control channel, from monitoring the second CORESET for a second downlink control channel, transmit the feedback in response to the first downlink control channel, and monitor, based on the feedback and switching from the first BWP to the second BWP, the first CORESET and the second CORESET for the second downlink control channel. By refraining from monitoring the second CORESET prior to transmission of feedback and then monitoring both CORESETs after feedback transmission, the processor 1400 may reduce power consumption during the transition period, while ensuring reliable control channel reception after the BWP switch is confirmed, thereby improving alignment between the UE and the NE regarding the active BWP.

Additionally, the processor 1400 may be configured to or operable to support any one or combination of to monitor, prior to the transmission of the feedback and after switching from the first BWP to the second BWP, at least a subset of the first CORESET for the second downlink control channel. By monitoring at least a subset of the first CORESET prior to feedback transmission and after switching, the processor 1400 may maintain control channel reception continuity during the transition period. Additionally, or alternatively, the processor 1400 may be configured to or operable to support to receive the second downlink control channel based on monitoring the first CORESET and the second CORESET, where the second downlink control channel schedules a downlink shared channel, receive the downlink shared channel, transmit additional feedback in response to decoding the downlink shared channel, and monitor the first CORESET and the second CORESET for one or more third downlink control channels based on the additional feedback. By receiving the second downlink control channel that schedules a downlink shared channel and transmitting additional feedback, the processor 1400 may enable reliable data reception and acknowledgment mechanisms that improve communication throughput. Additionally, or alternatively, the first BWP and the second BWP include one or more overlapping RBs, and the processor 1400 may be configured to or operable to support to determine at least one RB index associated with the downlink shared channel based on a set of RB indices associated with the first BWP, where the downlink shared channel is received in the one or more overlapping RBs based on the at least one RB index. By determining RB indices based on the first BWP for overlapping RBs, the processor 1400 may enable seamless data reception during BWP transitions without additional resource reallocation.

Additionally, or alternatively, the processor 1400 may be configured to or operable to support to start, after receiving the first downlink control channel, a timer associated with monitoring the first CORESET for the second downlink control channel, and refrain from monitoring the first CORESET for the second downlink control channel based on expiry of the timer. By utilizing a timer for monitoring the first CORESET, the processor 1400 may improve power consumption by limiting the monitoring duration to a defined period. Additionally, or alternatively, the first downlink control channel schedules a downlink shared channel, and the processor 1400 may be configured to or operable to support to receive the downlink shared channel, where the feedback includes an acknowledgment in response to decoding the downlink shared channel. By providing acknowledgment feedback in response to decoding the downlink shared channel, the processor 1400 may enable an NE to confirm successful data delivery and reduce retransmission overhead. Additionally, or alternatively, the processor 1400 may be configured to or operable to support the first downlink control channel is independent of a downlink shared channel, and the feedback includes an acknowledgment in response to decoding the first downlink control channel. By providing acknowledgment feedback for control channel reception independent of shared channel scheduling, the processor 1400 may enable explicit confirmation of BWP switch indications, thereby reducing misalignment between the NE and the processor 1400.

Additionally, or alternatively, the signaling indicates a first numerical quantity of time resources associated with the first CORESET in the first BWP and a second numerical quantity of time resources associated with the first CORESET in the second BWP, and the processor 1400 may be configured to or operable to support to monitor, prior to the transmission of the feedback and after switching from the first BWP to the second BWP, the first CORESET for the second downlink control channel based on the first numerical quantity of time resources, and monitor, after transmitting the feedback, the first CORESET for the second downlink control channel based on the second numerical quantity of time resources. By utilizing different numerical quantities of time resources for monitoring before and after feedback transmission, the processor 1400 may enable flexible CORESET configuration that adapts to the BWP switching state. Additionally, or alternatively, the signaling indicates a first numerical quantity of time resources associated with the first CORESET in the first BWP and a second numerical quantity of time resources associated with the first CORESET in the second BWP, and the processor 1400 may be configured to or operable to support to monitor, prior to the transmission of the feedback and after switching from the first BWP to the second BWP, the first CORESET for the second downlink control channel based on the second numerical quantity of time resources. By monitoring based on the second numerical quantity of time resources prior to feedback transmission, the processor 1400 may enable early adoption of the target BWP configuration for improved transition efficiency. Additionally, or alternatively, the processor 1400 may be configured to or operable to support to refrain from performing radio frequency retuning based on the first BWP and the second BWP including one or more overlapping RBs and having a same center frequency. By refraining from radio frequency retuning when BWPs have overlapping RBs and the same center frequency, the processor 1400 may reduce switching latency and power consumption during BWP transitions.

Additionally, or alternatively, the processor 1400 may be configured to or operable to support to monitor, prior to the transmission of the feedback and after switching from the first BWP to the second BWP, the first CORESET for the second downlink control channel based on a search space set associated with the first CORESET in the first BWP. By monitoring based on the search space set associated with the first CORESET in the first BWP, the processor 1400 may maintain consistent control channel monitoring behavior during the transition period. Additionally, or alternatively, the processor 1400 may be configured to or operable to support the first CORESET includes a set of one or more CORESETs configured for the first BWP. By supporting the first CORESET as a set of one or more CORESETs configured for the first BWP, the processor 1400 may enable flexible CORESET configurations that accommodate various deployment scenarios. Additionally, or alternatively, the processor 1400 may be configured to or operable to support to select the first CORESET from a set of CORESETs configured for the first BWP based on one or more of a size of the first CORESET having a greatest value of the set of CORESETs, the first CORESET being configured for BWP switching, or the first CORESET having a greatest numerical quantity of overlapping RBs between the first BWP and the second BWP. By selecting the first CORESET based on size, BWP switching configuration, or overlapping RBs, the processor 1400 may improve control channel reception reliability during BWP transitions. Additionally, or alternatively, the processor 1400 may be configured to or operable to support to monitor, prior to the transmission of the feedback and after switching from the first BWP to the second BWP, the first CORESET for the second downlink control channel based on the second BWP being greater than the first BWP. By monitoring the first CORESET when the second BWP is greater than the first BWP, the processor 1400 may ensure control channel reception continuity when transitioning to a larger bandwidth configuration.

The processor 1400 may be configured to or operable to support at least one controller (e.g., the controller 1402) coupled with at least one memory (e.g., the memory 1404) and configured to cause the processor to transmit signaling that indicates a first CORESET and a second CORESET, where the first CORESET is associated with a first BWP and a second BWP, and where the second CORESET is associated with the second BWP, transmit, in the first CORESET, a first downlink control channel that indicates to switch from the first BWP to the second BWP, refrain from transmitting, prior to reception of feedback in response to the first downlink control channel, a second downlink control channel in the second CORESET, receive the feedback in response to the first downlink control channel, and transmit, based on the feedback and in at least one of the first CORESET or the second CORESET, the second downlink control channel. By refraining from transmitting in the second CORESET prior to reception of feedback and then transmitting in both CORESETs after feedback reception, the processor 1400 may reduce power consumption during the transition period, while ensuring reliable control channel reception after the BWP switch is confirmed, thereby improving alignment between the UE and the NE regarding the active BWP.

Additionally, the processor 1400 may be configured to or operable to support any one or combination of to transmit, prior to the reception of the feedback and after transmitting the first downlink control channel, the second downlink control channel in at least a subset of the first CORESET. By transmitting the second downlink control channel in at least a subset of the first CORESET prior to feedback reception, the processor 1400 may maintain control channel transmission continuity during the transition period. Additionally, or alternatively, the processor 1400 may be configured to or operable to support to transmit the second downlink control channel, where the second downlink control channel schedules a downlink shared channel, transmit the downlink shared channel, receive additional feedback in response to decoding the downlink shared channel, and transmit one or more third downlink control channels in the first CORESET and the second CORESET based on the additional feedback. By transmitting the second downlink control channel that schedules a downlink shared channel and receiving additional feedback, the processor 1400 may enable reliable data delivery and acknowledgment mechanisms that improve overall communication throughput. Additionally, or alternatively, the first BWP and the second BWP include one or more overlapping RBs, and the processor 1400 may be configured to or operable to support to determine at least one RB index associated with the downlink shared channel based on a set of RB indices associated with the first BWP, where the downlink shared channel is transmitted in the one or more overlapping RBs based on the at least one RB index. By determining RB indices based on the first BWP for overlapping RBs, the processor 1400 may enable seamless data transmission during BWP transitions without additional resource reallocation.

Additionally, or alternatively, the first downlink control channel schedules a downlink shared channel, and the processor 1400 may be configured to or operable to support to transmit the downlink shared channel to a UE, where the feedback includes an acknowledgement that indicates successful reception and decoding of the downlink shared channel at the UE. By receiving acknowledgement feedback indicating successful reception and decoding of the downlink shared channel, the processor 1400 may confirm data delivery and reduce retransmissions. Additionally, or alternatively, the processor 1400 may be configured to or operable to support the first downlink control channel is independent of a downlink shared channel, and the feedback includes an acknowledgment in response to decoding the first downlink control channel. By receiving acknowledgment feedback for control channel reception independent of shared channel scheduling, the processor 1400 may obtain explicit confirmation of BWP switch indication reception, thereby reducing misalignment with the receiving device. Additionally, or alternatively, the signaling indicates a first numerical quantity of time resources associated with the first CORESET in the first BWP and a second numerical quantity of time resources associated with the first CORESET in the second BWP, and the processor 1400 may be configured to or operable to support to transmit, prior to the reception of the feedback and after transmitting the first downlink control channel, the second downlink control channel during the first CORESET based on the first numerical quantity of time resources, and transmit, after receiving the feedback, the second downlink control channel during the first CORESET based on the second numerical quantity of time resources. By utilizing different numerical quantities of time resources for transmission before and after feedback reception, the processor 1400 may enable flexible CORESET configuration that adapts to the BWP switching state.

Additionally, or alternatively, the signaling indicates a first numerical quantity of time resources associated with the first CORESET in the first BWP and a second numerical quantity of time resources associated with the first CORESET in the second BWP, and the processor 1400 may be configured to or operable to support to transmit, prior to the reception of the feedback and after transmitting the first downlink control channel, the second downlink control channel during the first CORESET based on the second numerical quantity of time resources. By transmitting based on the second numerical quantity of time resources prior to feedback reception, the processor 1400 may enable early adoption of the target BWP configuration for improved transition efficiency. Additionally, or alternatively, the processor 1400 may be configured to or operable to support to transmit, prior to the reception of the feedback and after transmitting the first downlink control channel, the second downlink control channel during the first CORESET based on a search space set associated with the first CORESET in the first BWP. By transmitting based on the search space set associated with the first CORESET in the first BWP, the processor 1400 may maintain consistent control channel transmission behavior during the transition period.

Additionally, or alternatively, the processor 1400 may be configured to or operable to support the first CORESET includes a set of one or more CORESETs configured for the first BWP. By supporting the first CORESET as a set of one or more CORESETs configured for the first BWP, the processor 1400 may enable flexible CORESET configurations that accommodate various deployment scenarios. Additionally, or alternatively, the processor 1400 may be configured to or operable to support to select the first CORESET from a set of CORESETs configured for the first BWP based on one or more of a size of the first CORESET having a greatest value of the set of CORESETs, the first CORESET being configured for BWP switching, or the first CORESET having a greatest numerical quantity of overlapping RBs between the first BWP and the second BWP. By selecting the first CORESET based on size, BWP switching configuration, or overlapping RBs, the processor 1400 may improve control channel transmission reliability during BWP transitions. Additionally, or alternatively, the processor 1400 may be configured to or operable to support to transmit, prior to the reception of the feedback and after transmitting the first downlink control channel, the second downlink control channel during the first CORESET based on the second BWP being greater than the first BWP. By transmitting the second downlink control channel during the first CORESET when the second BWP is greater than the first BWP, the processor 1400 may ensure control channel transmission continuity when transitioning to a larger bandwidth configuration.

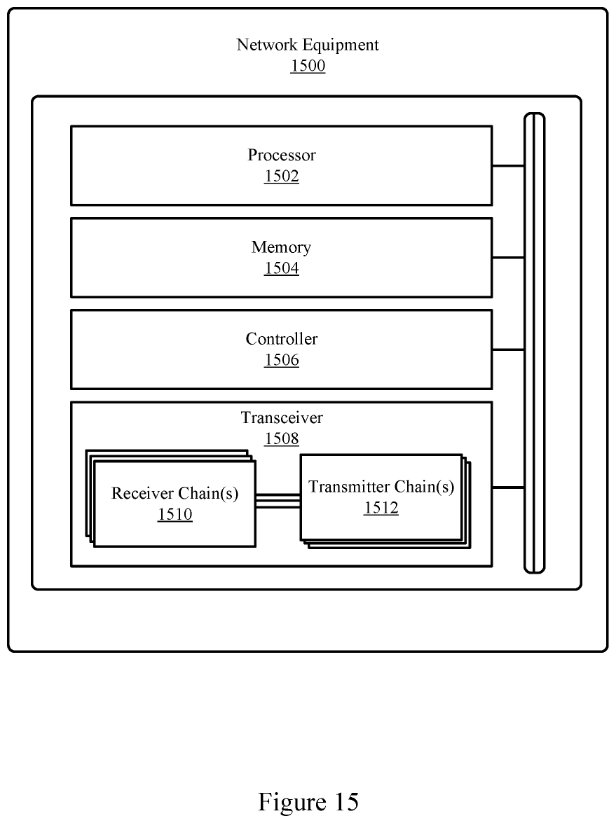

FIG. 15 illustrates an example of an NE 1500 in accordance with aspects of the present disclosure. The NE 1500 may include a processor 1502, a memory 1504, a controller 1506, and a transceiver 1508. The processor 1502, the memory 1504, the controller 1506, or the transceiver 1508, or various combinations thereof or various components thereof may be examples of means for performing various aspects of the present disclosure as described herein. These components may be coupled (e.g., operatively, communicatively, functionally, electronically, electrically) via one or more interfaces.

The processor 1502, the memory 1504, the controller 1506, or the transceiver 1508, or various combinations or components thereof may be implemented in hardware (e.g., circuitry). The hardware may include a processor, a DSP, an ASIC, or other programmable logic device, or any combination thereof, configured as or otherwise supporting a means for performing the functions described in the present disclosure.

The processor 1502 may include an intelligent hardware device (e.g., a general-purpose processor, a DSP, a CPU, an ASIC, an FPGA, or any combination thereof). In some implementations, the processor 1502 may be configured to operate the memory 1504. In some other implementations, the memory 1504 may be integrated into the processor 1502. The processor 1502 may be configured to execute computer-readable instructions stored in the memory 1504 to cause the NE 1500 to perform various functions of the present disclosure.

The memory 1504 may include volatile or non-volatile memory. The memory 1504 may store computer-readable, computer-executable code, including instructions that, when executed by the processor 1502, cause the NE 1500 to perform various functions described herein. The code may be stored in a non-transitory computer-readable medium, such as the memory 1504 or another type of memory. Computer-readable media include both non-transitory computer storage media and communication media, including any medium that facilitates transfer of a computer program from one place to another. A non-transitory storage medium may be any available medium that may be accessed by a general-purpose or special-purpose computer.

In some implementations, the processor 1502 and the memory 1504, coupled with the processor 1502, may be configured to cause the NE 1500 to perform one or more of the functions described herein (e.g., executing, by the processor 1502, instructions stored in the memory 1504). For example, the processor 1502 may support wireless communication at the NE 1500 in accordance with examples as disclosed herein.

The NE 1500 may be configured to or operable to support a means for transmitting signaling that indicates a first CORESET and a second CORESET, where the first CORESET is associated with a first BWP and a second BWP, and where the second CORESET is associated with the second BWP, transmitting, in the first CORESET, a first downlink control channel that indicates to switch from the first BWP to the second BWP, refraining from transmitting, prior to reception of feedback in response to the first downlink control channel, a second downlink control channel in the second CORESET, receiving the feedback in response to the first downlink control channel, and transmitting, based on the feedback and in at least one of the first CORESET or the second CORESET, the second downlink control channel. By refraining from transmitting in the second CORESET prior to reception of feedback and then transmitting in both CORESETs after feedback reception, the NE 1500 may reduce power consumption during the transition period, while ensuring reliable control channel reception after the BWP switch is confirmed, thereby improving alignment between the UE and the NE 1500 regarding the active BWP.

Additionally, the NE 1500 may be configured to or operable to support any one or combination of transmitting, prior to the reception of the feedback and after transmitting the first downlink control channel, the second downlink control channel in at least a subset of the first CORESET. By transmitting the second downlink control channel in at least a subset of the first CORESET prior to feedback reception, the NE 1500 may maintain control channel transmission continuity during the transition period. Additionally, or alternatively, the NE 1500 may be configured to or operable to support transmitting the second downlink control channel, where the second downlink control channel schedules a downlink shared channel, transmit the downlink shared channel, receiving additional feedback in response to decoding the downlink shared channel, and transmitting one or more third downlink control channels in the first CORESET and the second CORESET based on the additional feedback. By transmitting the second downlink control channel that schedules a downlink shared channel and receiving additional feedback, the NE 1500 may enable reliable data delivery and acknowledgment mechanisms that improve overall communication throughput. Additionally, or alternatively, the first BWP and the second BWP include one or more overlapping RBs, and the NE 1500 may be configured to or operable to support determining at least one RB index associated with the downlink shared channel based on a set of RB indices associated with the first BWP, where the downlink shared channel is transmitted in the one or more overlapping RBs based on the at least one RB index. By determining RB indices based on the first BWP for overlapping RBs, the NE 1500 may enable seamless data transmission during BWP transitions without additional resource reallocation.

Additionally, or alternatively, the first downlink control channel schedules a downlink shared channel, and the NE 1500 may be configured to or operable to support transmitting the downlink shared channel to a UE, where the feedback includes an acknowledgement that indicates successful reception and decoding of the downlink shared channel at the UE. By receiving acknowledgement feedback indicating successful reception and decoding of the downlink shared channel, the NE 1500 may confirm data delivery and reduce retransmissions. Additionally, or alternatively, the NE 1500 may be configured to or operable to support the first downlink control channel is independent of a downlink shared channel, and the feedback includes an acknowledgment in response to decoding the first downlink control channel. By receiving acknowledgment feedback for control channel reception independent of shared channel scheduling, the NE 1500 may obtain explicit confirmation of BWP switch indication reception, thereby reducing misalignment with the UE.

Additionally, or alternatively, the signaling indicates a first numerical quantity of time resources associated with the first CORESET in the first BWP and a second numerical quantity of time resources associated with the first CORESET in the second BWP, and the NE 1500 may be configured to or operable to support transmitting, prior to the reception of the feedback and after transmitting the first downlink control channel, the second downlink control channel during the first CORESET based on the first numerical quantity of time resources, and transmitting, after receiving the feedback, the second downlink control channel during the first CORESET based on the second numerical quantity of time resources. By utilizing different numerical quantities of time resources for transmission before and after feedback reception, the NE 1500 may enable flexible CORESET configuration that adapts to the BWP switching state. Additionally, or alternatively, the signaling indicates a first numerical quantity of time resources associated with the first CORESET in the first BWP and a second numerical quantity of time resources associated with the first CORESET in the second BWP, and the NE 1500 may be configured to or operable to support transmitting, prior to the reception of the feedback and after transmitting the first downlink control channel, the second downlink control channel during the first CORESET based on the second numerical quantity of time resources. By transmitting based on the second numerical quantity of time resources prior to feedback reception, the NE 1500 may enable early adoption of the target BWP configuration for improved transition efficiency.

Additionally, or alternatively, the NE 1500 may be configured to or operable to support transmitting, prior to the reception of the feedback and after transmitting the first downlink control channel, the second downlink control channel during the first CORESET based on a search space set associated with the first CORESET in the first BWP. By transmitting based on the search space set associated with the first CORESET in the first BWP, the NE 1500 may maintain consistent control channel transmission behavior during the transition period. Additionally, or alternatively, the NE 1500 may be configured to or operable to support the first CORESET includes a set of one or more CORESETs configured for the first BWP. By supporting the first CORESET as a set of one or more CORESETs configured for the first BWP, the NE 1500 may enable flexible CORESET configurations that accommodate various deployment scenarios. Additionally, or alternatively, the NE 1500 may be configured to or operable to support selecting the first CORESET from a set of CORESETs configured for the first BWP based on one or more of a size of the first CORESET having a greatest value of the set of CORESETs, the first CORESET being configured for BWP switching, or the first CORESET having a greatest numerical quantity of overlapping RBs between the first BWP and the second BWP. By selecting the first CORESET based on size, BWP switching configuration, or overlapping RBs, the NE 1500 may improve control channel transmission reliability during BWP transitions. Additionally, or alternatively, the NE 1500 may be configured to or operable to support transmitting, prior to the reception of the feedback and after transmitting the first downlink control channel, the second downlink control channel during the first CORESET based on the second BWP being greater than the first BWP. By transmitting the second downlink control channel during the first CORESET when the second BWP is greater than the first BWP, the NE 1500 may ensure control channel transmission continuity when transitioning to a larger bandwidth configuration.

Additionally, or alternatively, the NE 1500 may support at least one memory (e.g., the memory 1504) and at least one processor (e.g., the processor 1502) coupled with the at least one memory and configured to cause the NE to transmit signaling that indicates a first CORESET and a second CORESET, where the first CORESET is associated with a first BWP and a second BWP, and where the second CORESET is associated with the second BWP, transmit, in the first CORESET, a first downlink control channel that indicates to switch from the first BWP to the second BWP, refrain from transmitting, prior to reception of feedback in response to the first downlink control channel, a second downlink control channel in the second CORESET, receive the feedback in response to the first downlink control channel, and transmit, based on the feedback and in at least one of the first CORESET or the second CORESET, the second downlink control channel.

Additionally, the NE 1500 may be configured to or operable to support any one or combination of to transmit, prior to the reception of the feedback and after transmitting the first downlink control channel, the second downlink control channel in at least a subset of the first CORESET. Additionally, or alternatively, the NE 1500 may be configured to or operable to support to transmit the second downlink control channel, where the second downlink control channel schedules a downlink shared channel, transmit the downlink shared channel, receive additional feedback in response to decoding the downlink shared channel, and transmit one or more third downlink control channels in the first CORESET and the second CORESET based on the additional feedback. Additionally, or alternatively, the first BWP and the second BWP include one or more overlapping RBs, and the NE 1500 may be configured to or operable to support to determine at least one RB index associated with the downlink shared channel based on a set of RB indices associated with the first BWP, where the downlink shared channel is transmitted in the one or more overlapping RBs based on the at least one RB index.

Additionally, or alternatively, the first downlink control channel schedules a downlink shared channel, and the NE 1500 may be configured to or operable to support to transmit the downlink shared channel to a UE, where the feedback includes an acknowledgement that indicates successful reception and decoding of the downlink shared channel at the UE. Additionally, or alternatively, the NE 1500 may be configured to or operable to support the first downlink control channel is independent of a downlink shared channel, and the feedback includes an acknowledgment in response to decoding the first downlink control channel.

Additionally, or alternatively, the signaling indicates a first numerical quantity of time resources associated with the first CORESET in the first BWP and a second numerical quantity of time resources associated with the first CORESET in the second BWP, and the NE 1500 may be configured to or operable to support to transmit, prior to the reception of the feedback and after transmitting the first downlink control channel, the second downlink control channel during the first CORESET based on the first numerical quantity of time resources, and transmit, after receiving the feedback, the second downlink control channel during the first CORESET based on the second numerical quantity of time resources. Additionally, or alternatively, the signaling indicates a first numerical quantity of time resources associated with the first CORESET in the first BWP and a second numerical quantity of time resources associated with the first CORESET in the second BWP, and the NE 1500 may be configured to or operable to support to transmit, prior to the reception of the feedback and after transmitting the first downlink control channel, the second downlink control channel during the first CORESET based on the second numerical quantity of time resources.

Additionally, or alternatively, the NE 1500 may be configured to or operable to support to transmit, prior to the reception of the feedback and after transmitting the first downlink control channel, the second downlink control channel during the first CORESET based on a search space set associated with the first CORESET in the first BWP. Additionally, or alternatively, the NE 1500 may be configured to or operable to support the first CORESET includes a set of one or more CORESETs configured for the first BWP. Additionally, or alternatively, the NE 1500 may be configured to or operable to support to select the first CORESET from a set of CORESETs configured for the first BWP based on one or more of a size of the first CORESET having a greatest value of the set of CORESETs, the first CORESET being configured for BWP switching, or the first CORESET having a greatest numerical quantity of overlapping RBs between the first BWP and the second BWP. Additionally, or alternatively, the NE 1500 may be configured to or operable to support to transmit, prior to the reception of the feedback and after transmitting the first downlink control channel, the second downlink control channel during the first CORESET based on the second BWP being greater than the first BWP.

The controller 1506 may manage input and output signals for the NE 1500. The controller 1506 may also manage peripherals not integrated into the NE 1500. In some implementations, the controller 1506 may utilize an operating system such as iOS®, Android®, Windows®, or other operating systems. In some implementations, the controller 1506 may be implemented as part of the processor 1502.

In some implementations, the NE 1500 may include at least one transceiver 1508. In some other implementations, the NE 1500 may have more than one transceiver 1508. The transceiver 1508 may represent a wireless transceiver. The transceiver 1508 may include one or more receiver chains 1510, one or more transmitter chains 1512, or a combination thereof.

A receiver chain 1510 may be configured to receive signals (e.g., control information, data, packets) over a wireless medium. For example, the receiver chain 1510 may include one or more antennas to receive a signal over the air or wireless medium. The receiver chain 1510 may include at least one amplifier (e.g., an LNA) configured to amplify the received signal. The receiver chain 1510 may include at least one demodulator configured to demodulate the received signal and obtain the transmitted data by reversing the modulation technique applied during transmission of the signal. The receiver chain 1510 may include at least one decoder for decoding the demodulated signal to receive the transmitted data.

A transmitter chain 1512 may be configured to generate and transmit signals (e.g., control information, data, packets). The transmitter chain 1512 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 1512 may also include at least one power amplifier configured to amplify the modulated signal to an appropriate power level suitable for transmission over the wireless medium. The transmitter chain 1512 may also include one or more antennas for transmitting the amplified signal into the air or wireless medium.

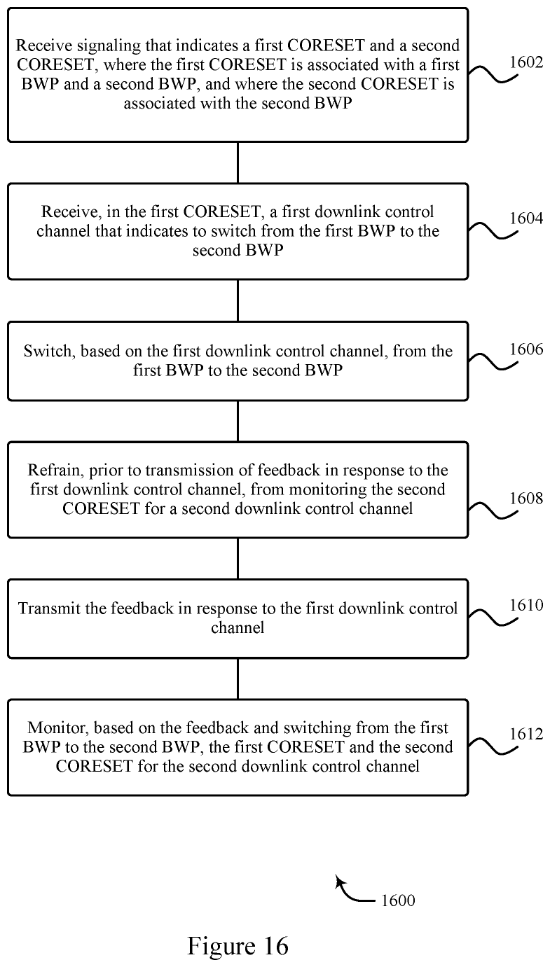

FIG. 16 illustrates a flowchart of a method 1600 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified, and that other implementations are possible.

At 1602, the method may include receiving signaling that indicates a first CORESET and a second CORESET, where the first CORESET is associated with a first BWP and a second BWP, and where the second CORESET is associated with the second BWP. The operations of 1602 may be performed in accordance with examples as described herein. In some implementations, aspects of the operations of 1602 may be performed by a UE as described with reference to FIG. 13.

At 1604, the method may include receiving, in the first CORESET, a first downlink control channel that indicates to switch from the first BWP to the second BWP. The operations of 1604 may be performed in accordance with examples as described herein. In some implementations, aspects of the operations of 1604 may be performed by a UE as described with reference to FIG. 13.

At 1606, the method may include switching, based on the first downlink control channel, from the first BWP to the second BWP. The operations of 1606 may be performed in accordance with examples as described herein. In some implementations, aspects of the operations of 1606 may be performed by a UE as described with reference to FIG. 13.

At 1608, the method may include refraining, prior to transmission of feedback in response to the first downlink control channel, from monitoring the second CORESET for a second downlink control channel. The operations of 1608 may be performed in accordance with examples as described herein. In some implementations, aspects of the operations of 1608 may be performed by a UE as described with reference to FIG. 13.

At 1610, the method may include transmitting the feedback in response to the first downlink control channel. The operations of 1610 may be performed in accordance with examples as described herein. In some implementations, aspects of the operations of 1610 may be performed by a UE as described with reference to FIG. 13.

At 1612, the method may include monitoring, based on the feedback and switching from the first BWP to the second BWP, the first CORESET and the second CORESET for the second downlink control channel. The operations of 1612 may be performed in accordance with examples as described herein. In some implementations, aspects of the operations of 1612 may be performed by a UE as described with reference to FIG. 13.

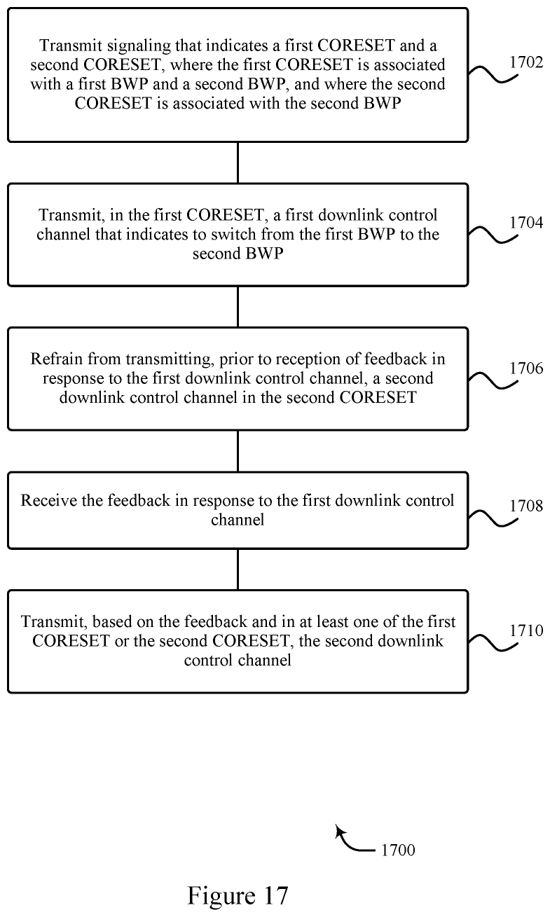

FIG. 17 illustrates a flowchart of a method 1700 in accordance with aspects of the present disclosure. The operations of the method may be implemented by an NE as described herein. In some implementations, the NE may execute a set of instructions to control the functional elements of the NE to perform the described functions. It should be noted that the method described herein describes a possible implementation, and that the operations and the steps may be rearranged or otherwise modified, and that other implementations are possible.

At 1702, the method may include transmitting signaling that indicates a first CORESET and a second CORESET, where the first CORESET is associated with a first BWP and a second BWP, and where the second CORESET is associated with the second BWP. The operations of 1702 may be performed in accordance with examples as described herein. In some implementations, aspects of the operations of 1702 may be performed by an NE as described with reference to FIG. 15.

At 1704, the method may include transmitting, in the first CORESET, a first downlink control channel that indicates to switch from the first BWP to the second BWP. The operations of 1704 may be performed in accordance with examples as described herein. In some implementations, aspects of the operations of 1704 may be performed by an NE as described with reference to FIG. 15.

At 1706, the method may include refraining from transmitting, prior to reception of feedback in response to the first downlink control channel, a second downlink control channel in the second CORESET. The operations of 1706 may be performed in accordance with examples as described herein. In some implementations, aspects of the operations of 1706 may be performed by an NE as described with reference to FIG. 15.

At 1708, the method may include receiving the feedback in response to the first downlink control channel. The operations of 1708 may be performed in accordance with examples as described herein. In some implementations, aspects of the operations of 1708 may be performed by an NE as described with reference to FIG. 15.

At 1710, the method may include transmitting, based on the feedback and in at least one of the first CORESET or the second CORESET, the second downlink control channel. The operations of 1710 may be performed in accordance with examples as described herein. In some implementations, aspects of the operations of 1710 may be performed by an NE as described with reference to FIG. 15.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive signaling that indicates a first control resource set (CORESET) and a second CORESET, wherein the first CORESET is associated with a first bandwidth part (BWP) and a second BWP, and wherein the second CORESET is associated with the second BWP;
receive, in the first CORESET, a first downlink control channel that indicates to switch from the first BWP to the second BWP;
switch, based at least in part on the first downlink control channel, from the first BWP to the second BWP;
refrain, prior to transmission of feedback in response to the first downlink control channel, from monitoring the second CORESET for a second downlink control channel;
transmit the feedback in response to the first downlink control channel; and
monitor, based at least in part on the feedback and switching from the first BWP to the second BWP, the first CORESET and the second CORESET for the second downlink control channel.

2. The UE of claim 1, wherein the at least one processor is further operable to cause the UE to monitor, prior to the transmission of the feedback and after switching from the first BWP to the second BWP, at least a subset of the first CORESET for the second downlink control channel.

3. The UE of claim 2, wherein the at least one processor is further operable to cause the UE to:
receive the second downlink control channel based at least in part on monitoring the first CORESET and the second CORESET, wherein the second downlink control channel schedules a downlink shared channel;
receive the downlink shared channel;
transmit additional feedback in response to decoding the downlink shared channel; and
monitor the first CORESET and the second CORESET for one or more third downlink control channels based at least in part on the additional feedback.

4. The UE of claim 3, wherein the first BWP and the second BWP comprise one or more overlapping resource blocks (RBs), and wherein the at least one processor is further operable to cause the UE to determine at least one RB index associated with the downlink shared channel based at least in part on a plurality of RB indices associated with the first BWP, wherein the downlink shared channel is received in the one or more overlapping RBs based at least in part on the at least one RB index.

5. The UE of claim 1, wherein the at least one processor is further operable to cause the UE to:
start, after receiving the first downlink control channel, a timer associated with monitoring the first CORESET for the second downlink control channel; and
refrain from monitoring the first CORESET for the second downlink control channel based at least in part on expiry of the timer.

6. The UE of claim 1, wherein the first downlink control channel schedules a downlink shared channel, and wherein the at least one processor is further operable to cause the UE to receive the downlink shared channel, wherein the feedback comprises an acknowledgment in response to decoding the downlink shared channel.

7. The UE of claim 1, wherein the first downlink control channel is independent of a downlink shared channel, and wherein the feedback comprises an acknowledgment in response to decoding the first downlink control channel.

8. The UE of claim 1, wherein the signaling indicates a first numerical quantity of time resources associated with the first CORESET in the first BWP and a second numerical quantity of time resources associated with the first CORESET in the second BWP, and wherein the at least one processor is further operable to cause the UE to:
monitor, prior to the transmission of the feedback and after switching from the first BWP to the second BWP, the first CORESET for the second downlink control channel based at least in part on the first numerical quantity of time resources; and
monitor, after transmitting the feedback, the first CORESET for the second downlink control channel based at least in part on the second numerical quantity of time resources.

9. The UE of claim 1, wherein the signaling indicates a first numerical quantity of time resources associated with the first CORESET in the first BWP and a second numerical quantity of time resources associated with the first CORESET in the second BWP, and wherein the at least one processor is further operable to cause the UE to monitor, prior to the transmission of the feedback and after switching from the first BWP to the second BWP, the first CORESET for the second downlink control channel based at least in part on the second numerical quantity of time resources.

10. The UE of claim 1, wherein the at least one processor is further operable to cause the UE to refrain from performing radio frequency retuning based at least in part on the first BWP and the second BWP comprising one or more overlapping resource blocks (RBs) and having a same center frequency.

11. The UE of claim 1, wherein the at least one processor is further operable to cause the UE to monitor, prior to the transmission of the feedback and after switching from the first BWP to the second BWP, the first CORESET for the second downlink control channel based at least in part on a search space set associated with the first CORESET in the first BWP.

12. The UE of claim 1, wherein the first CORESET comprises a set of one or more CORESETs configured for the first BWP.

13. The UE of claim 1, wherein the at least one processor is further operable to cause the UE to select the first CORESET from a set of CORESETs configured for the first BWP based at least in part on one or more of a size of the first CORESET having a greatest value of the set of CORESETs, the first CORESET being configured for BWP switching, or the first CORESET having a greatest numerical quantity of overlapping resource blocks (RBs) between the first BWP and the second BWP.

14. The UE of claim 1, wherein the at least one processor is further operable to cause the UE to monitor, prior to the transmission of the feedback and after switching from the first BWP to the second BWP, the first CORESET for the second downlink control channel based at least in part on the second BWP being greater than the first BWP.

15. A method performed by a user equipment (UE), the method comprising:
receiving signaling that indicates a first control resource set (CORESET) and a second CORESET, wherein the first CORESET is associated with a first bandwidth part (BWP) and a second BWP, and wherein the second CORESET is associated with the second BWP;
receiving, in the first CORESET, a first downlink control channel that indicates to switch from the first BWP to the second BWP;
switching, based at least in part on the first downlink control channel, from the first BWP to the second BWP;
refraining, prior to transmission of feedback in response to the first downlink control channel, from monitoring the second CORESET for a second downlink control channel;
transmitting the feedback in response to the first downlink control channel; and
monitoring, based at least in part on the feedback and switching from the first BWP to the second BWP, the first CORESET and the second CORESET for the second downlink control channel.

16. A network equipment (NE) for wireless communication, comprising:
at least one memory; and
at least one processor coupled with the at least one memory and operable to cause the NE to:
transmit signaling that indicates a first control resource set (CORESET) and a second CORESET, wherein the first CORESET is associated with a first bandwidth part (BWP) and a second BWP, and wherein the second CORESET is associated with the second BWP;
transmit, in the first CORESET, a first downlink control channel that indicates to switch from the first BWP to the second BWP;
refrain from transmitting, prior to reception of feedback in response to the first downlink control channel, a second downlink control channel in the second CORESET;
receive the feedback in response to the first downlink control channel; and
transmit, based at least in part on the feedback and in at least one of the first CORESET or the second CORESET, the second downlink control channel.

17. The NE of claim 16, wherein the at least one processor is further operable to cause the NE to transmit, prior to the reception of the feedback and after transmitting the first downlink control channel, the second downlink control channel in at least a subset of the first CORESET.

18. The NE of claim 16, wherein the first downlink control channel schedules a downlink shared channel, and wherein the at least one processor is further operable to cause the NE to transmit the downlink shared channel to a user equipment (UE), wherein the feedback comprises an acknowledgement that indicates successful reception and decoding of the downlink shared channel at the UE.

19. The NE of claim 16, wherein the first downlink control channel is independent of a downlink shared channel, and wherein the feedback comprises an acknowledgment in response to decoding the first downlink control channel.

20. A method performed by a network equipment (NE), the method comprising:
transmitting signaling that indicates a first control resource set (CORESET) and a second CORESET, wherein the first CORESET is associated with a first bandwidth part (BWP) and a second BWP, and wherein the second CORESET is associated with the second BWP;
transmitting, in the first CORESET, a first downlink control channel that indicates to switch from the first BWP to the second BWP;
refraining from transmitting, prior to reception of feedback in response to the first downlink control channel, a second downlink control channel in the second CORESET;
receiving the feedback in response to the first downlink control channel; and
transmitting, based at least in part on the feedback and in at least one of the first CORESET or the second CORESET, the second downlink control channel.
